(19) United States
(12) Patent Application Publication
(10) Pub. No.: US 2026/0242667 A1
(43) Pub. Date: Aug. 20, 2026

(54) FILM, POLARIZING PLATE, AND IMAGE DISPLAY DEVICE

(71) Applicant: FUJIFILM Corporation, Tokyo (JP)

(72) Inventors: Ayako MURAMATSU, Minamiashigara-shi (JP); Hiroki KUWAHARA, Minamiashigara-shi (JP); Katsumi SASATA, Minamiashigara-shi (JP); Kunihiro KASEZAWA, Minamiashigara-shi (JP)

(73) Assignee: FUJIFILM Corporation, Tokyo (JP)

(21) Appl. No.: 19/641,530

(22) Filed: Apr. 8, 2026

Related U.S. Application Data
(63) Continuation of application No. PCT/JP2024/036338, filed on Oct. 10, 2024.

(30) Foreign Application Priority Data
Nov. 17, 2023 (JP) 2023-195588
Jun. 27, 2024 (JP) 2024-103981

(51) Int. Cl. C09K 19/54; G02B 5/30

(52) U.S. Cl. CPC C09K 19/542; G02B 5/3016

(57) ABSTRACT

An object of the present invention is to provide a film formed of a liquid crystal composition containing a leveling agent having a silicon atom, which has excellent adhesiveness to an adjacent layer. The film according to the embodiment of the present invention is a film formed of a liquid crystal composition containing a liquid crystal compound and a leveling agent containing a silicon atom, in which a binding energy of a peak top in an inner-shell photoelectron spectrum of Si2p obtained by measuring a surface of the film by X-ray photoelectron spectroscopy is 102.0 eV or more, or a silicon atom to which four oxygen atoms are bonded is present on the surface of the film.

### CROSS-REFERENCE TO RELATED APPLICATIONS

This application is a Continuation of PCT International Application No. PCT/JP2024/036338 filed on Oct. 10, 2024, which claims priority under 35 U.S.C. § 119(a) to Japanese Patent Application No. 2023-195588 filed on Nov. 17, 2023 and Japanese Patent Application No. 2024-103981 filed on Jun. 27, 2024. The above applications are hereby expressly incorporated by reference, in their entirety, into the present application.

### BACKGROUND OF THE INVENTION

### 1. Field of the Invention

The present invention relates to a film, a polarizing plate, and an image display device.

### 2. Description of the Related Art

An optical film such as an optical compensation sheet and a retardation film is used in various image display devices in order to eliminate image coloration or to expand a viewing angle.

A stretched birefringent film has been used as the optical film, but in recent years, it has been proposed to use an optical film having an optically anisotropic layer consisting of a liquid crystal compound instead of the stretched birefringent film.

The optically anisotropic layer consisting of a liquid crystal compound is often formed by applying a liquid crystal composition containing a liquid crystal compound to form a coating film and performing an alignment treatment on the coating film.

In the liquid crystal composition, a leveling agent may be added in order to improve surface properties on an air interface side in a case of forming a coating film. For example, WO2019/160044A discloses a liquid crystal composition to which a fluorine-based leveling agent containing a fluorine atom is added.

### SUMMARY OF THE INVENTION

In recent years, due to the non-degradability and toxicity thereof, the regulation of perfluoroalkyl compounds and polyfluoroalkyl compounds (PFAS) has been promoted, and the use of alternatives that do not use a fluorine atom, typically alternative materials containing a silicon atom, has been studied.

As a result of studying a liquid crystal composition using a leveling agent containing a silicon atom, the present inventors have found that the adhesiveness between a film formed of the liquid crystal composition and a layer (for example, an adhesive layer) adjacent to the film does not satisfy a desired level and needs to be improved.

Therefore, an object of the present invention is to provide a film formed of a liquid crystal composition containing a leveling agent having a silicon atom, which has excellent adhesiveness to an adjacent layer.

In addition, another object of the present invention is to provide a polarizing plate and an image display device, which are related to the above-described film.

As a result of conducting an extensive investigation to achieve the objects, the present inventors have found that the objects can be achieved by the following configuration.
[1] A film formed of a liquid crystal composition containing a liquid crystal compound and a leveling agent containing a silicon atom, in which a binding energy of a peak top in a photoelectron spectrum of Si2p obtained by measuring a surface of the film by X-ray photoelectron spectroscopy is 102.0 eV or more.
[2] A film formed of a liquid crystal composition containing a liquid crystal compound and a leveling agent containing a silicon atom, in which a silicon atom to which four oxygen atoms are bonded is present on a surface of the film.
[3] The film according to [2], in which, in a photoelectron spectrum of Si2p obtained by measuring the surface of the film by X-ray photoelectron spectroscopy, a peak surface area attributed to the silicon atom to which four oxygen atoms are bonded is 30% or more with respect to a peak surface area of the photoelectron spectrum of Si2p.
[4] The film according to any one of [1] to [3], in which a surface elastic modulus of the film is 4.0 GPa or more.
[5] The film according to any one of [1] to [4], in which a surface adsorption force of the film is 12.0 nN or more.
[6] A polarizing plate comprising: a polarizer; an adhesive layer; and the film according to any one of [1] to [5].
[7] An image display device including: the polarizing plate according to [6].
[8] The image display device according to [7], in which the image display device is an organic electroluminescent display device.
[9] The image display device according to [7], in which the image display device is a liquid crystal display device.

According to the present invention, it is possible to provide a film having excellent adhesiveness to an adjacent layer.

In addition, it is also possible to provide a polarizing plate and an image display device, which are related to the film.

### BRIEF DESCRIPTION OF THE DRAWINGS

FIG. 1 is a schematic cross-sectional view showing an example of a laminate including a film according to the embodiment of the present invention.

FIG. 2 is a schematic cross-sectional view showing an example of a polarizing plate including the film according to the embodiment of the present invention.

### DESCRIPTION OF THE PREFERRED EMBODIMENTS

Hereinafter, the present invention will be described in detail.

The description of the configuration requirements described below may be made based on the representative embodiments of the present invention, but the present invention is not limited to those embodiments.

In the present specification, a numerical range expressed using “to” means a range that includes the preceding and succeeding numerical values of “to” as a lower limit value and an upper limit value, respectively.

In addition, in the present specification, in a case where there are two or more components corresponding to a certain component, “content” of such a component means the total content of the two or more components.

In the present specification, regarding numerical ranges that are described stepwise, an upper limit value or a lower limit value described in a numerical range may be replaced with an upper limit value or a lower limit value of another stepwise numerical range. In addition, in the numerical range described in the present specification, an upper limit value and a lower limit value described in a certain numerical range may be replaced with values shown in Examples.

In the present specification, a combination of two or more preferred aspects is a more preferred aspect.

A bonding direction of a divalent group (for example, —CO—O—) described in the present specification is not limited unless otherwise specified. For example, in a case where Y in a compound represented by a formula “X—Y—Z” is —CO—O—, the compound may be “X—O—CO—Z” or “X—CO—O—Z”.

In the present specification, “(meth)acrylic” is a concept including both acrylic and methacrylic, “(meth)acryloyl” is a concept including both acryloyl and methacryloyl, “(meth)acrylate” is a concept including both acrylate and methacrylate, and “(meth)acrylonitrile” is a concept including both acrylonitrile and methacrylonitrile.

In the present specification, the slow axis is defined at 550 nm unless otherwise specified.

In the present specification, Re(λ) and Rth(λ) represent an in-plane retardation and a thickness-direction retardation at a wavelength λ, respectively. Unless otherwise specified, the wavelength λ refers to 550 nm.

In addition, in the present specification, Re(λ) and Rth(λ) are values measured at the wavelength λ in AxoScan OPMF-1 (manufactured by Opto Science, Inc.).

Specifically, by inputting an average refractive index ((nx+ny+nz)/3) and a film thickness (d (μm)) in AxoScan OPMF-1,
a slow axis direction (°)

$$R e ( λ ) = R 0 ( λ )$$

$$Rth ( λ ) = ( ( n x + ny ) / 2 - nz ) \times d$$

are calculated.

Although R0(λ) is displayed as a numerical value calculated by AxoScan OPMF-1, R0(λ) means Re(λ).

In addition, in the present specification, a relationship between angles (for example, “orthogonal”, “parallel”, and the like) is intended to include a range of errors acceptable in the art to which the present invention belongs. Specifically, it means that an angle is within an error range of less than ±10° with respect to the exact angle, and the error with respect to the exact angle is preferably within a range of ±5° or less and more preferably within a range of ±3° or less.

In the present specification, the solid content is intended to be a component forming a film, and does not include a solvent. A component forming a film is regarded as a solid content even in a case where the component has a liquid property.

### [Film]

Hereinafter, the film according to the embodiment of the present invention will be described in detail.

A film according to a first aspect of the present invention is a film formed of a liquid crystal composition containing a liquid crystal compound and a leveling agent containing a silicon atom, in which a binding energy of a peak top in a photoelectron spectrum of Si2p obtained by measuring a surface of the film with X-ray photoelectron spectroscopy is 102.0 eV or more.

A film according to a second aspect of the present invention is a film formed of a liquid crystal composition containing a liquid crystal compound and a leveling agent containing a silicon atom, in which a silicon atom to which four oxygen atoms are bonded is present on a surface.

In the present specification, a case of simply being referred to as “film according to the embodiment of the present invention” indicates a concept including both the film according to the first aspect and the film according to the second aspect.

The reason why the transfer film having the above-described configuration can achieve the object of the present invention is not necessarily clear, but the present inventors speculate as follows.

The mechanism by which the effect is obtained is not limited by the following speculation. In other words, even in a case where the effect is obtained by a mechanism other than the one described below, it is still included within the scope of the present invention.

In the film according to the first aspect of the present invention, the binding energy of the peak top of the photoelectron spectrum of Si2p is a predetermined value or more on the surface. In such a case, it is considered that a proportion of silicon atoms contained in the film having an Si-O bond having a higher binding energy than an Si-C bond or the like is large. It is presumed that as the number of Si-O bonds increases, the strength of the film surface increases, the breakage is suppressed, the surface adsorption force, the polarity, and the like are improved, and as a result, the adhesiveness to an adjacent layer is excellent.

In the film according to the second aspect of the present invention, a silicon atom to which four oxygen atoms are bonded is present on the surface. The silicon atom to which four oxygen atoms are bonded is considered to be present in a state of silicon dioxide (SiO₂). It is presumed that as silicon dioxide is contained, the strength of the film surface increases, the breakage is suppressed, the surface adsorption force, the polarity, and the like are improved, and as a result, the adhesiveness to an adjacent layer is excellent.

Hereinafter, the fact that the adhesiveness of the film according to the embodiment of the present invention to an adjacent layer is more excellent is also simply referred to as “the effect of the present invention is more excellent”.

Hereinafter, a liquid crystal composition used for forming the film according to the embodiment of the present invention, a manufacturing method of the film, and characteristics of the film will be described in this order.

### [Liquid Crystal Composition]

The liquid crystal composition contains a liquid crystal compound and a leveling agent containing a silicon atom (hereinafter, also referred to as “specific leveling agent”).

### <Liquid Crystal Compound>

The liquid crystal compound contained in the liquid crystal composition is not particularly limited.

In general, the liquid crystal compound can be classified into a rod-like type and a disk-like type depending on the shape thereof. Furthermore, each type includes a low-molecular-weight type and a high-molecular-weight type. The “high-molecular-weight” generally refers to a compound having a degree of polymerization of 100 or more (Polymer Physics-Phase Transition Dynamics, written by Masao Doi, p. 2, published by Iwanami Shoten, 1992). In the present invention, any liquid crystal compound can be used, but a rod-like liquid crystal compound or a disk-like liquid crystal compound (discotic liquid crystal compound) is preferably used. A mixture of two or more kinds of the rod-like liquid crystal compounds, a mixture of two or more kinds of the disk-like liquid crystal compounds, or a mixture of the rod-like liquid crystal compound and the disk-like liquid crystal compound may be used.

The liquid crystal compound contained in the liquid crystal composition may be either a low molecular weight liquid crystal compound or a polymer liquid crystal compound, or may be a mixture thereof.

The liquid crystal compound is preferably a polymerizable liquid crystal compound, from the viewpoint of aligning properties.

The polymerizable liquid crystal compound is a liquid crystal compound having a polymerizable group, and the alignment state thereof can be immobilized by polymerizing the compound after alignment. In addition, the alignment state of the polymer liquid crystal compound can be immobilized by removing the solvent from the liquid crystal composition after the alignment of the compound and drying the composition.

The polymerizable liquid crystal compound is preferably at least one polymerizable liquid crystal compound selected from the group consisting of a polymerizable rod-like liquid crystal compound and a polymerizable disk-like liquid crystal compound.

The polymerizable group contained in the polymerizable liquid crystal compound is not particularly limited, and is preferably a polymerizable group capable of radical polymerization or cationic polymerization. Examples of the polymerizable group include an acryloyl group, a methacryloyl group, an epoxy group, and a vinyl group.

The rod-like liquid crystal compound is preferably one described in claim 1 of JP1999-513019A (JP-H11-513019A) or paragraphs [0026] to [0098] of JP2005-289980A, and the discotic liquid crystal compound is preferably one described in paragraphs [0020] to [0067] of JP2007-108732A or paragraphs [0013] to [0108] of JP2010-244038A.

A liquid crystal compound having reverse wavelength dispersibility (reverse dispersibility compound) may be used as the liquid crystal compound. In the present specification, the liquid crystal compound having “reverse wavelength dispersibility” refers to a liquid crystal compound in which, in a case where an in-plane retardation (Re) value of a film produced using such a liquid crystal compound is measured at a specific wavelength (visible light range), the Re value is equal to or higher than an increase in measurement wavelength.

The liquid crystal compound having reverse wavelength dispersibility is not particularly limited as long as it can form a layer having reverse wavelength dispersibility, and examples thereof include the compounds represented by General Formula (I) described in JP2008-297210A (particularly, the compounds described in paragraphs [0034] to [0039]), the compounds represented by General Formula (1) described in JP2010-084032A (particularly, the compounds described in paragraphs [0067] to [0073]), the compounds represented by General Formula (1) described in JP2016-081035A (particularly, the compounds described in paragraphs [0043] to [0055]), and the compounds represented by General Formula (II) described in JP2016-053709A (particularly, the compounds described in paragraphs [0036] to [0043]).

Further, examples thereof include compounds described in paragraphs [0027] to [0100] of JP2011-006360A, paragraphs [0028] to [0125] of JP2011-006361A, paragraphs [0034] of JP2012-207765A, paragraphs [0016] to [0345] of JP2012-077055A, paragraphs [0017] to [0072] of WO2012/141245A, paragraphs [0021] to [0088] of WO2012/147904A, paragraphs [0028] to [0115] of WO2014/147904A, and paragraphs [0025] to [0056] of WO2021/060427A.

The liquid crystal compounds may be used alone or in combination of two or more thereof.

The content of the liquid crystal compound is preferably 50% to 99.99% by mass, and more preferably 70% to 99% by mass with respect to the total solid content of the composition.

### <Leveling Agent Containing Silicon Atom>

The liquid crystal composition contains a leveling agent (specific leveling agent) containing a silicon atom.

A structure of the specific leveling agent is not limited as long as it contains a silicon atom, but is preferably a polymer having a repeating unit containing a silicon atom (repeating unit A).

### (Repeating Unit A)

The repeating unit A is a repeating unit containing a silicon atom.

The number of silicon atoms contained in the repeating unit A is 1 or more, preferably 2 or more, more preferably 3 to 6, and still more preferably 3 to 5.

It is preferable that the repeating unit A contains a silicon atom having a structure represented by Formula (Ia).

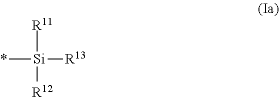

In Formula (Ia), * represents a bonding position.

R¹¹, R¹², and R¹³ each independently represent an alkyl group, an alkenyl group, an aryl group, or an alkylene aryl group, which may have a substituent. As the substituent, a halogen atom, an alkyl group, an alkenyl group, an alkylcarbonyl group, an alkyloxycarbonyl group, an alkylcarbonyloxy group, or an alkoxy group is preferable.

Examples of the above-described alkyl group include a linear alkyl group having 1 to 18 carbon atoms and a branched or cyclic alkyl group having 3 to 18 carbon atoms. Specific examples thereof include a methyl group, an ethyl group, a propyl group, a butyl group, an isopropyl group, a tert-butyl group, and a cyclohexyl group.

Examples of the alkenyl group include an alkenyl group having 2 to 12 carbon atoms.

Examples of the aryl group include an aryl group having 6 to 12 carbon atoms.

Examples of the alkylene aryl group include an alkylene aryl group having 7 to 30 carbon atoms.

From the viewpoint of more excellent leveling properties, it is preferable that all of R¹¹, R¹², and R¹³ are alkyl groups.

From the viewpoint that the effect of the present invention is more excellent, the repeating unit A preferably has 2 or more structures represented by Formula (Ia), more preferably has 3 to 6 structures represented by Formula (Ia), and still more preferably has 3 to 5 structures represented by Formula (Ia).

From the viewpoint that the effect of the present invention is more excellent, the structure represented by Formula (Ia) is preferably bonded to a carbon atom or an oxygen atom. In other words, it is preferable that the repeating unit A has a structure represented by —O-A or a structure represented by —CR^{A}₂-A. A represents the structure represented by Formula (Ia). R^{A}'s each independently represent a hydrogen atom or a substituent. R^{A} may represent the structure represented by Formula (Ia).

From the viewpoint that the leveling properties and the compatibility with the liquid crystal compound are more excellent, the repeating unit A is preferably a repeating unit represented by Formula (a1).

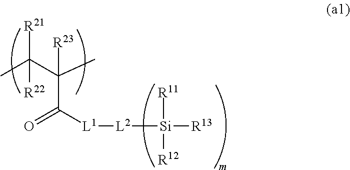

In Formula (a1), represents an integer of 1 or more. m is preferably an integer of 2 or more, more preferably an integer of 3 or more, still more preferably an integer of 3 to 6, and particularly preferably an integer of 3 to 5.

In Formula (a1), R¹¹, R¹², and R¹³ are the same as R¹¹, R¹², and R¹³ in Formula (Ia). A plurality of R¹¹'s may be the same or different from each other, a plurality of R¹²'s may be the same or different from each other, and a plurality of R¹³'s may be the same or different from each other.

In Formula (a1), R²¹ and R²² each independently represent a hydrogen atom or an alkyl group.

Examples of the above-described alkyl group include a linear alkyl group having 1 to 18 carbon atoms and a branched or cyclic alkyl group having 3 to 18 carbon atoms. It is preferable that R²¹ and R²² represent a hydrogen atom.

In Formula (a1), R²³ represents a hydrogen atom or a substituent.

Examples of the above-described substituent include a substituent having an alkyl group, an alkenyl group, an aryl group, or a linking group and containing a silicon atom. The substituent having a linking group and containing a silicon atom also includes —CH₂—CO-L¹-L²-(Si(R¹¹)(R¹²)(R¹³))ₘ. L¹, L², R¹¹, R¹², R¹³, and m are the same as the definitions of the symbols in Formula (a1).

R²³ is preferably a hydrogen atom or an alkyl group, more preferably a hydrogen atom or a linear alkyl group having 1 to 4 carbon atoms, still more preferably a hydrogen atom, a methyl group, or an ethyl group, and particularly preferably a hydrogen atom or a methyl group.

In Formula (a1), L¹ represents —O— or —NR^{Z}—. R^{Z} represents a hydrogen atom or a substituent.

Examples of the substituent represented by R^{Z} include the groups exemplified as the substituent represented by R²³, and an alkyl group is preferable, a linear alkyl group having 1 to 4 carbon atoms is more preferable, and a methyl group or an ethyl group is still more preferable.

L¹ is preferably —O— or —NH—, and more preferably —O—.

In Formula (a1), L² represents an (m+1)-valent linking group.

Suitable examples of the above-described (m+1)-valent linking group include an (m+1)-valent hydrocarbon group having 1 to 10 carbon atoms, which may have a substituent, in which a part of carbon atoms constituting the hydrocarbon group may be replaced with a heteroatom. As the substituent which may be included in the above-described hydrocarbon group, an alkyl group is preferable, a linear alkyl group having 1 to 4 carbon atoms is more preferable, and a methyl group or an ethyl group is still more preferable.

Examples of the heteroatom which may replace a part of the above-described carbon atoms include a silicon atom, an oxygen atom, and a nitrogen atom.

Examples of L² include a group represented by Structural Formula K-1-L, a group represented by Structural Formula K-2-L, and a group represented by Structural Formula K-3-L. In the following structural formulae, * represents a bonding position with L¹ in Formula (a1), and ** represents a bonding position with the group represented by —SiR¹¹R¹²R¹³ in Formula (a1).

L² may be a group represented by -alkylene group-O—(SiR¹⁴₂—O)ₙₗ—. The alkylene group is preferably a linear alkylene group having 1 to 4 carbon atoms. The definition and suitable aspects of R¹⁴ are the same as those of the group represented by R¹¹, R¹², and R¹³ is preferably an alkyl group and more preferably a methyl group or an ethyl group. nl represents an integer of 1 or more, and is preferably an integer of 1 to 80 and more preferably an integer of 1 to 16.

In addition, an atom that is bonded to the group represented by —SiR¹¹R¹²R¹³ in L² is preferably a carbon atom or an oxygen atom and more preferably an oxygen atom.

Among these, from the viewpoint that the effect of the present invention is more excellent, L² is preferably a group represented by Structural Formula K-1-L.

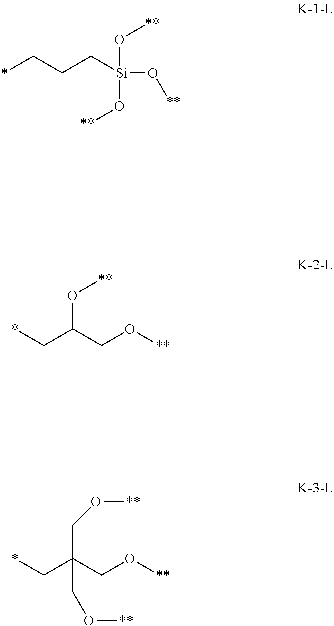

Specific examples of the repeating unit A include repeating units derived from monomers represented by K-1 to K-33. nBu represents an n-butyl group.

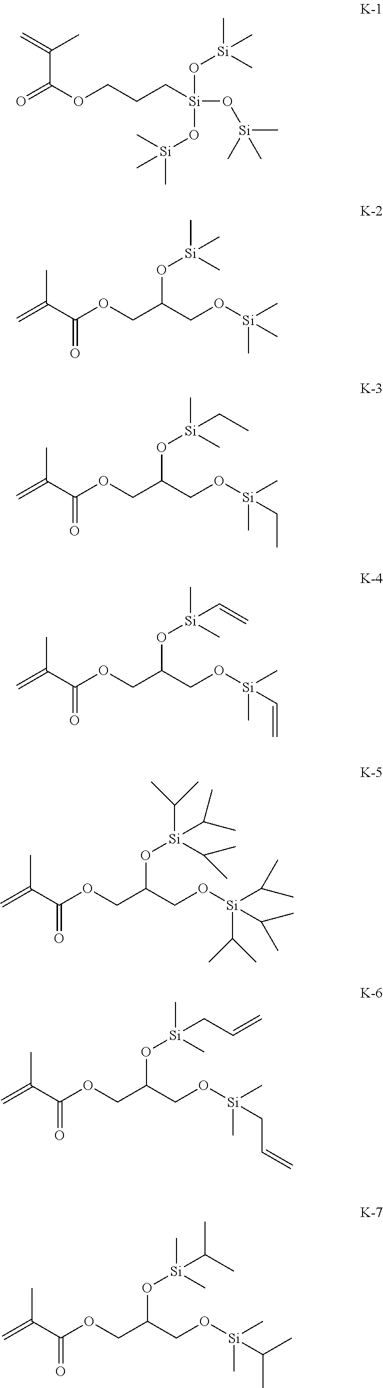

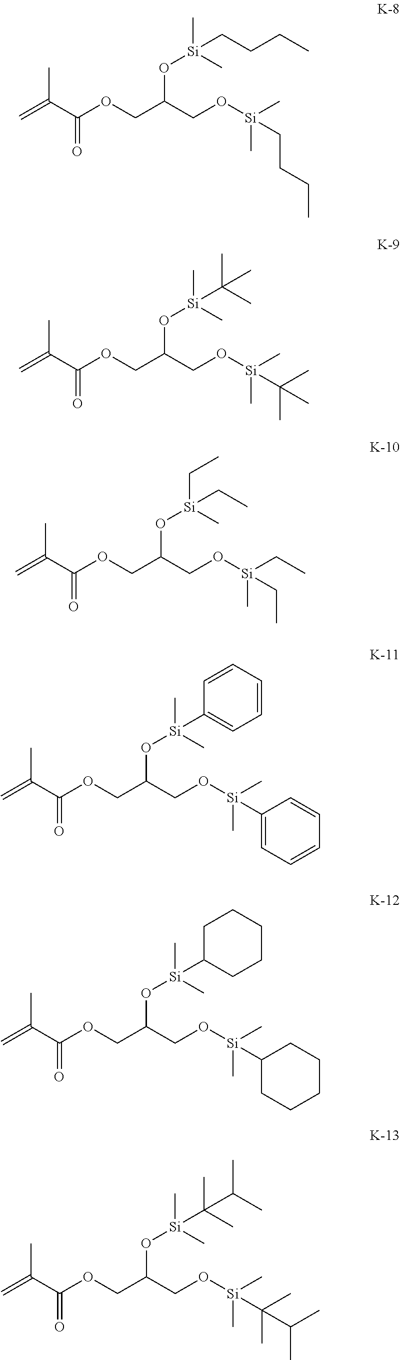

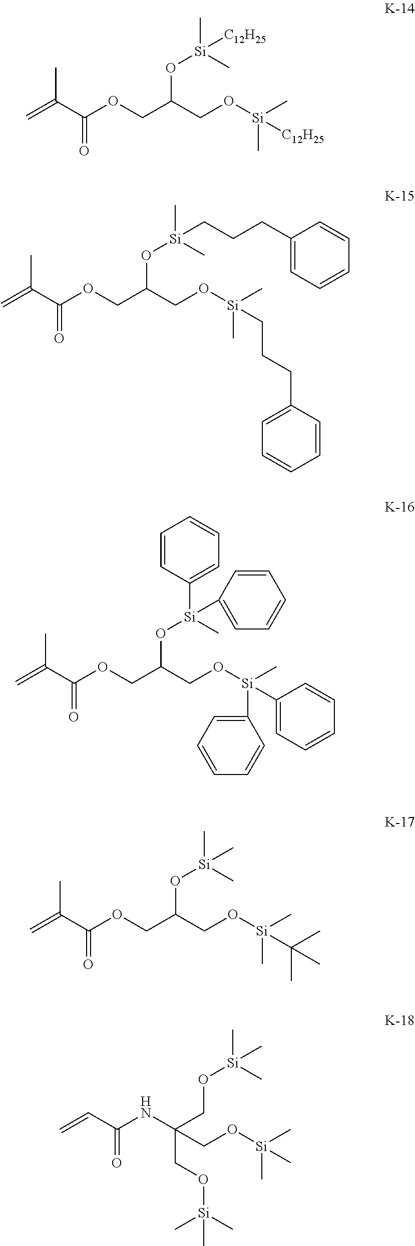

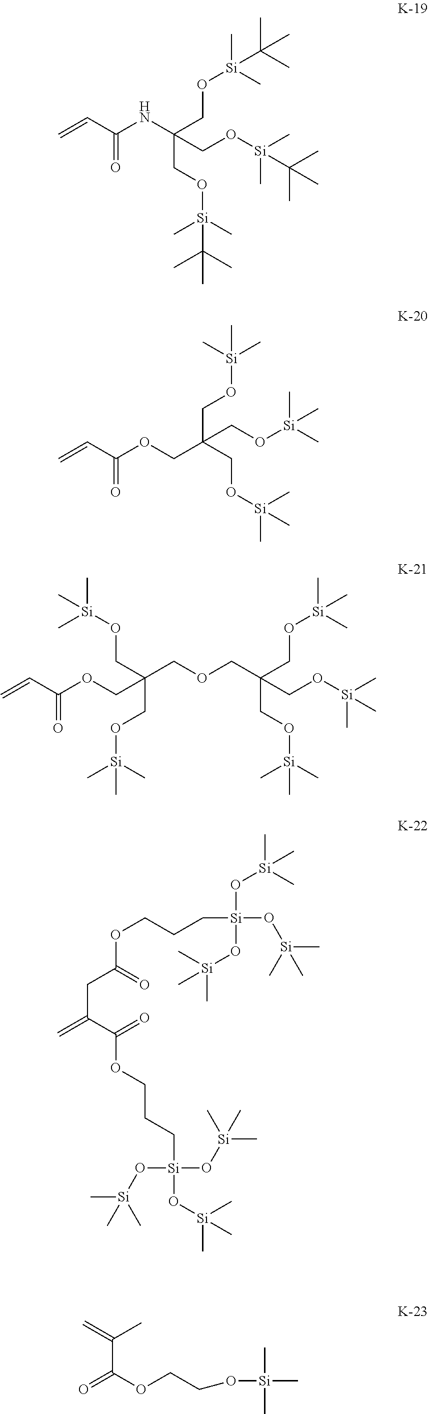

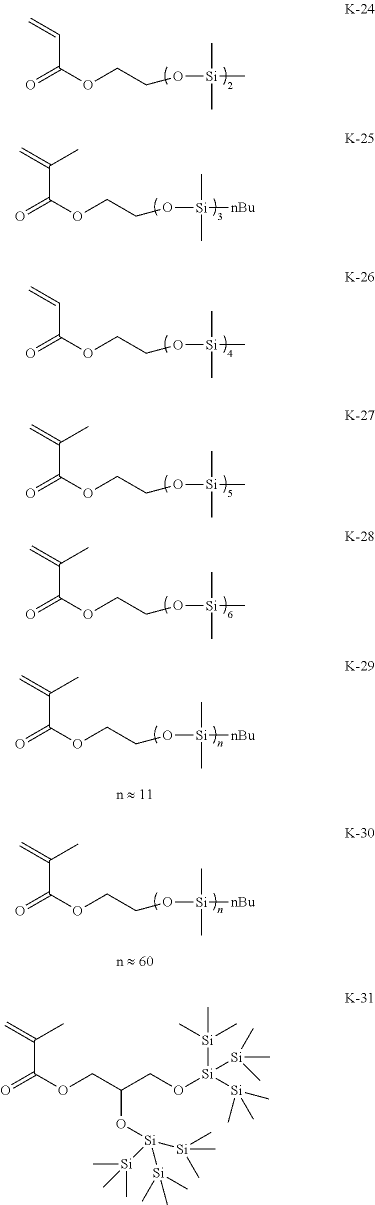

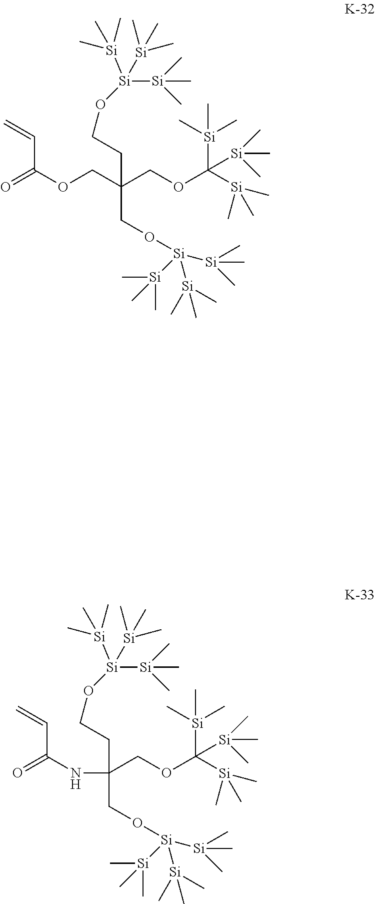

The repeating unit A may be used alone or in combination of two or more kinds thereof.

A content of the repeating unit A is preferably 20% by mass or more, more preferably 30% by mass or more, and still more preferably 40% by mass or more with respect to all repeating units (100% by mass) constituting the main chain of the specific leveling agent. The upper limit of the content of the repeating unit A may be 100% by mass, and is preferably 80% by mass or less, more preferably 70% by mass or less, and still more preferably 60% by mass or less with respect to all repeating units (100% by mass) constituting the main chain of the specific leveling agent.

The specific leveling agent may have a repeating unit other than the repeating unit A. From the viewpoint of controlling the alignment of the above-described liquid crystal compound, it is also preferable that the specific leveling agent has a repeating unit (repeating unit B) including a mesogen group.

From the viewpoint of more excellent adhesiveness with the adjacent layer, it is also preferable that the specific leveling agent has a repeating unit (repeating unit C) including a polymerizable group.

From the viewpoint of compatibility, it is also preferable that the specific leveling agent includes a repeating unit having a poly(alkyleneoxy) group. Details of the poly(alkyleneoxy) group will be described later.

The specific leveling agent preferably includes the repeating unit A and at least one repeating unit selected from the repeating unit B or the repeating unit C, and more preferably includes the repeating unit A, the repeating unit B, and the repeating unit C.

### (Repeating Unit B)

The repeating unit B is a repeating unit including a mesogen group.

As the above-described mesogen group, a known mesogen group can be used, and for example, “Flussige Kristalle in Tabellen II” (VEB Deutsche Verlag fur Grundstoff Industrie, Leipzig, 1984), particularly the description on pages 7 to 16, and “Liquid Crystal Handbook” (Maruzen, 2000), particularly the description in Chapter 3, edited by the Liquid Crystal Handbook Editing Committee, can be referred to.

As the mesogen group, for example, a group having at least one cyclic structure selected from the group consisting of an aromatic hydrocarbon group, a heterocyclic group, and an alicyclic group is preferable.

From the reason that the alignment degree of the liquid crystal compound is improved, the mesogen group is preferably a group having an aromatic hydrocarbon group or a group having an alicyclic group, which may have a substituent, more preferably a group having 2 to 4 aromatic hydrocarbon groups, which may have a substituent, and still more preferably a group having 3 aromatic hydrocarbon groups, which may have a substituent. The substituent is preferably an alkyl group, an alkoxy group, an alkyl ester group, or an acetyl group, and more preferably a methyl group, a tert-butyl group, a methoxy group, or a methyl ester group.

The mesogen group is preferably a group represented by Formula (Mi-A).

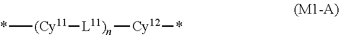

In Formula (M1-A), * represents a bonding position.

In Formula (M1-A), n represents an integer of 1 or more, and is preferably an integer of 1 to 10, more preferably an integer of 1 to 3, and still more preferably 2.

In Formula (M1-A), Cy¹¹ and Cy¹² each independently represent a divalent ring group which may have a substituent.

The divalent ring group may be any of a monocyclic ring or a polycyclic ring, and is preferably a monocyclic ring.

The number of ring members in the divalent ring group is preferably 5 to 18, more preferably 5 to 10, and still more preferably 5 or 6.

Examples of the divalent ring group include a divalent aromatic ring group and a divalent alicyclic group.

Examples of the divalent aromatic ring group include a divalent aromatic hydrocarbon ring group in which two hydrogen atoms have been removed from an aromatic hydrocarbon ring and a divalent aromatic heterocyclic group in which two hydrogen atoms have been removed from an aromatic heterocyclic ring. Examples of the aromatic hydrocarbon ring include a benzene ring, a naphthalene ring, an anthracene ring, and a phenanthrene ring. Examples of the aromatic heterocyclic ring include a pyridine ring, a pyridazine ring, an imidazole ring, a thiophene ring, a quinoline ring, an isoquinolylene ring, a phenanthroline ring, an oxazole ring, a thiazole ring, an oxadiazole ring, a benzothiazole ring, a benzothiadiazole ring, a phthalimide ring, a thienothiazole ring, a thiazolothiazole ring, a thienothiophene ring, and a thienooxazole ring. Among these, a group in which two hydrogen atoms have been removed from a benzene ring (for example, a 1,4-phenylene group) is preferable.

Examples of the divalent alicyclic group include a divalent aliphatic hydrocarbon ring group in which two hydrogen atoms have been removed from an aliphatic hydrocarbon ring (for example, a cycloalkane or a cycloalkene) and a divalent aliphatic heterocyclic group in which two hydrogen atoms have been removed from an aliphatic heterocyclic ring. Examples of the aliphatic hydrocarbon ring include a cyclopentane ring, a cyclohexane ring, a cycloheptane ring, a cyclooctane ring, a cyclononane ring, a cyclododecane ring, and a cyclodocosane ring. Examples of the aliphatic heterocyclic group include a pyrrolidine ring, an oxolane ring, a thiolane ring, a piperidine ring, a tetrahydropyran ring, a thiane ring, a piperazine ring, and a morpholine ring. Among these, a group in which two hydrogen atoms have been removed from a cyclohexane ring (for example, a 1,4-cyclohexylene group) is preferable.

The divalent ring group is preferably a divalent aromatic ring group or a divalent aliphatic hydrocarbon ring group, and more preferably a divalent aromatic ring group.

Examples of the substituent which may be included in the divalent ring group include an alkyl ester group, an alkyl group which may have a halogen atom, an acyl group, an alkoxy group, an alkylthio group, an alkyloxycarbonyl group, a carbamoyl group, an acylamino group, a halogen atom, a cyano group, and a nitro group, and an alkyl ester group, an alkyl group, or an acyl group is preferable, a methyl ester group, a linear alkyl group having 1 to 4 carbon atoms, or an acetyl group is more preferable, and a methyl ester group, a methyl group, or an ethyl group is still more preferable.

In Formula (M1-A), L¹¹'s each independently represent a single bond or a divalent linking group.

Examples of the divalent linking group include —CO—, —O—, —S—, —C(═S)—, —CR^{L1}R^{L2}—, —CR^{L3}═CR^{L4}—, and —NR^{L5}—, and a combination of two or more of these groups. R^{L1} to R^{L5} each independently represent a hydrogen atom or a substituent. As the substituent represented by R^{L1} to R^{L5}, a halogen atom, an alkyl group having 1 to 12 carbon atoms, or an alkoxy group having 1 to 12 carbon atoms is preferable.

L¹¹ is preferably —CO—, —O—, —CR^{L1}R^{L2}—, —NR^{L5}—, or a combination of two of these groups.

In a case where n is an integer of 2 or more and Cy¹¹'s represent a phenylene group, from the viewpoint of improving aligning properties in a case of horizontally aligning the liquid crystal compound, any one of two or more Cy¹¹'s is preferably linked at a meta position or an ortho position, and among these, from the viewpoint of improving aligning properties and cissing, it is preferable that any one of two or more Cy¹¹'s is linked at a meta position. On the other hand, in a case where the liquid crystal compound is vertically aligned, in any one of two or more Ph¹¹, a para position linkage is preferable.

From the viewpoint of improving compatibility with the liquid crystal compound and viewpoint of more excellent leveling properties, the repeating unit B is preferably a repeating unit represented by Formula (b1) or a repeating unit represented by Formula (b2), and it is more preferably a repeating unit represented by Formula (b1).

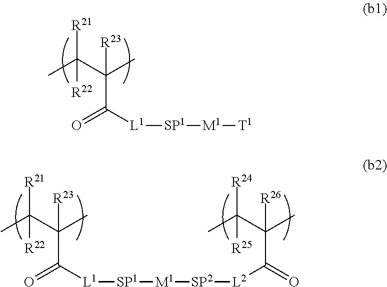

In Formulae (b1) and (b2), R²¹, R²², R²³, and L¹ are the same as those described in Formula (a1).

In Formula (b2), R²⁴ and R²⁵ each independently have the same definition as that for R²¹ and R²² in Formula (a1), and suitable aspects thereof are also the same. R²⁶ has the same definition as that for R²³ in Formula (a1), and suitable aspects thereof are also the same. L² has the same definition as that for L¹ in Formula (a1), and suitable aspects thereof are also the same.

In Formulae (b1) and (b2), SP¹ and SP² each independently represent a spacer group.

The spacer group is not particularly limited as long as it is a divalent linking group not including a ring structure, and examples thereof include a divalent chain-like aliphatic hydrocarbon group having 1 to 20 carbon atoms.

As the divalent chain-like aliphatic hydrocarbon group having 1 to 20 carbon atoms, a chain-like alkylene group having 1 to 15 carbon atoms is preferable, and a chain-like alkylene group having 1 to 8 carbon atoms is more preferable. Specific suitable examples thereof include a methylene group, an ethylene group, a propylene group, a butylene group, a pentylene group, a hexylene group, a methylhexylene group, and a heptylene group.

One or more of —CH₂—'s constituting the divalent chain-like aliphatic hydrocarbon group may be each independently substituted with a group selected from —O—, —S—, —CO—, and —N(Q)-. Two or more —CH₂—'s may be substituted as long as the same groups are not adjacent to each other. Q represents a hydrogen atom or a substituent. As the substituent represented by Q, an alkyl group is preferable, a linear alkyl group having 1 to 4 carbon atoms is more preferable, and a methyl group or an ethyl group is still more preferable.

Among these, as the spacer group, *—(CH₂—CH₂—O)ₙ₁—*, *—(CH₂)ₙ₂—O—*, or *—(CH₂)ₙ₂—O—CO—* is preferable, * represents a bonding position, n1 represents an integer of 1 to 4, and n2's each independently represent an integer of 1 to 6 and are preferably an integer of 2 to 4.

In Formula (b1) and Formula (b2), M¹ represents a mesogen group. The details of the mesogen group are as described above.

In Formula (b2), T¹ represents a terminal group. The terminal group represents a hydrogen atom or a substituent.

Examples of the substituent include a halogen atom, a cyano group, a nitro group, a hydroxy group, an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an alkoxycarbonyl group having 1 to 10 carbon atoms (ROC(O)—: R represents an alkyl group), an acyloxy group having 1 to 10 carbon atoms, an acylamino group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a trialkylsilyloxy group having 3 to 12 carbon atoms, and a ureido group having 1 to 10 carbon atoms.

Specific examples of the repeating unit B include repeating units derived from monomers represented by Q-1 to Q-32.

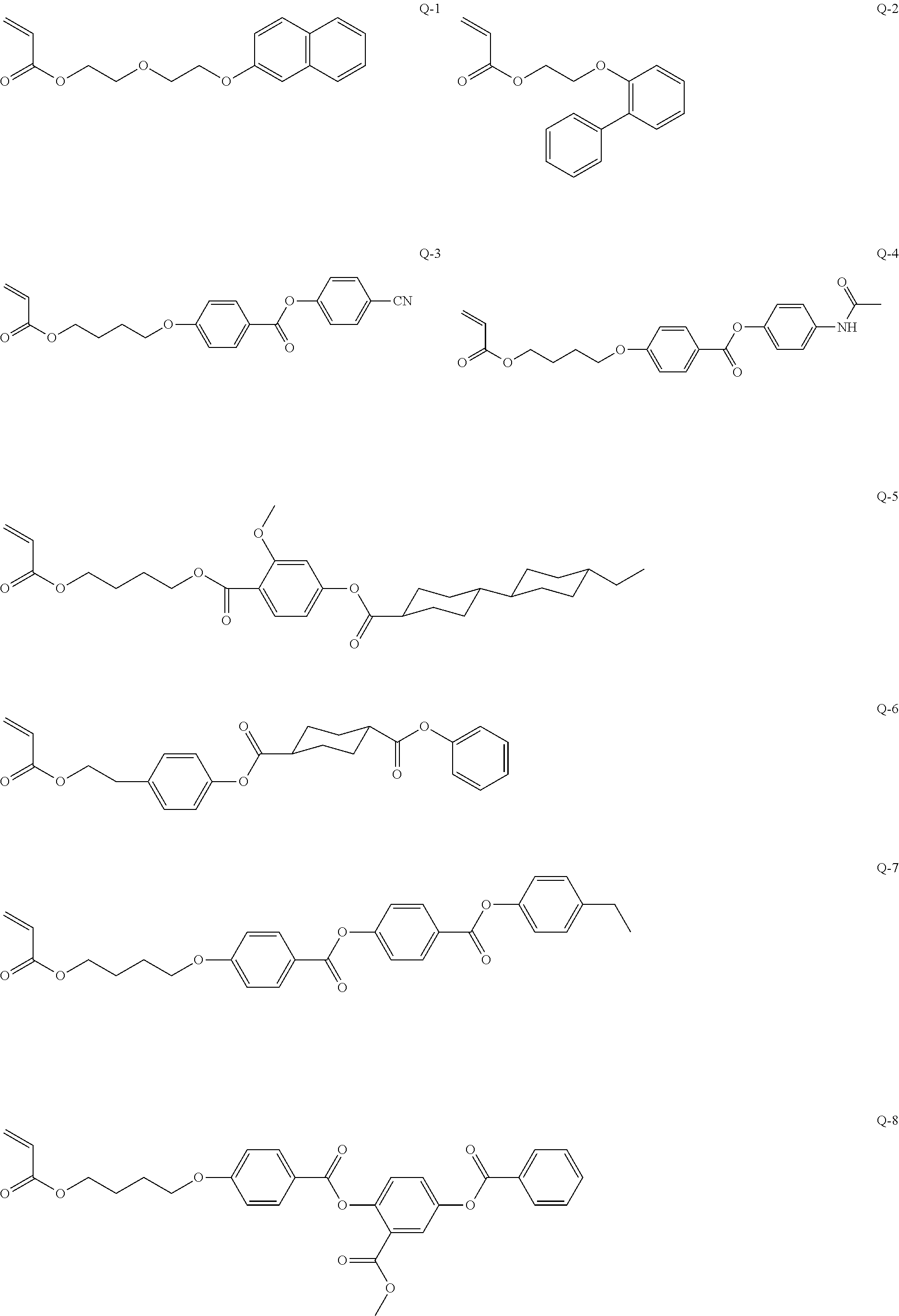

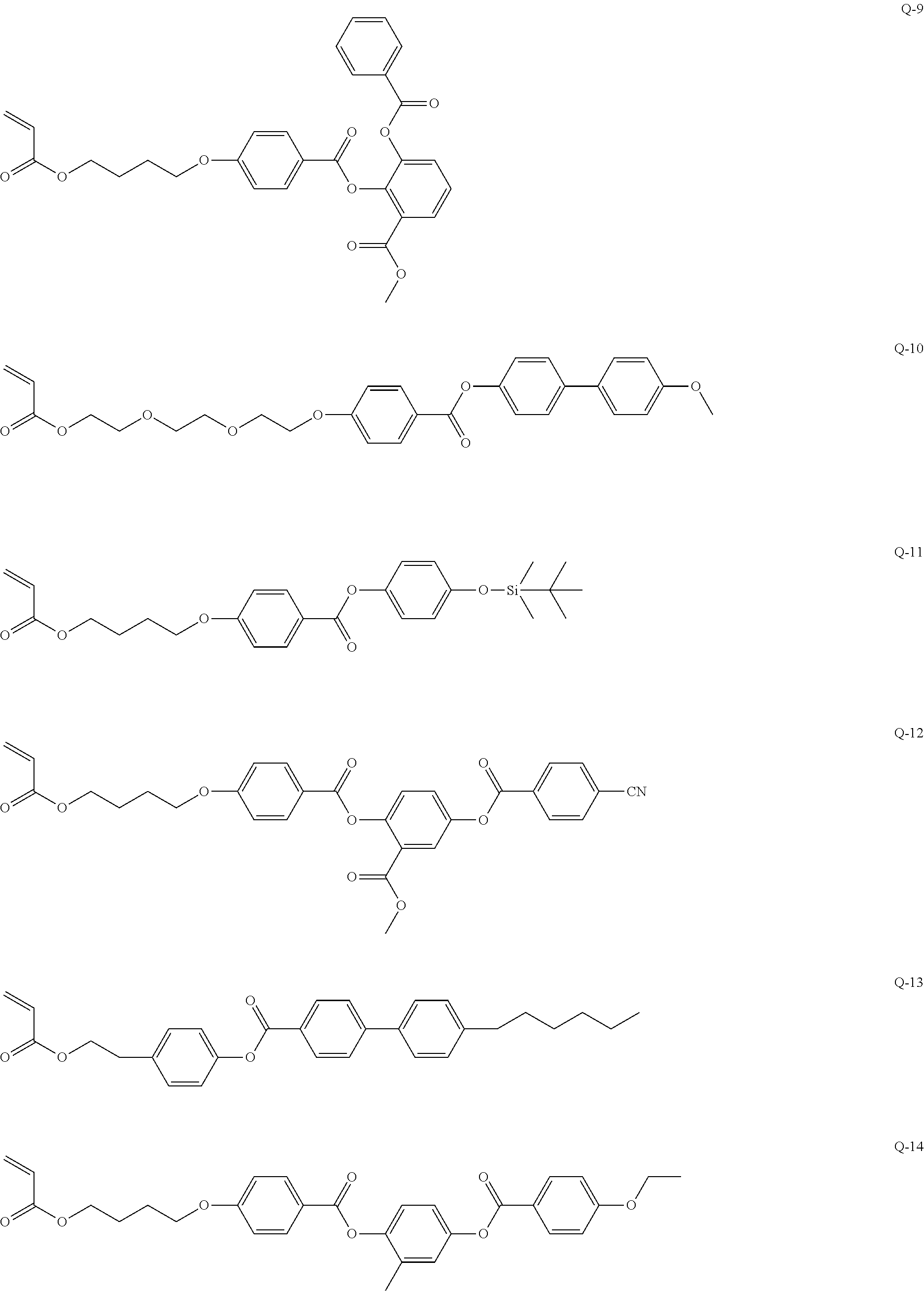

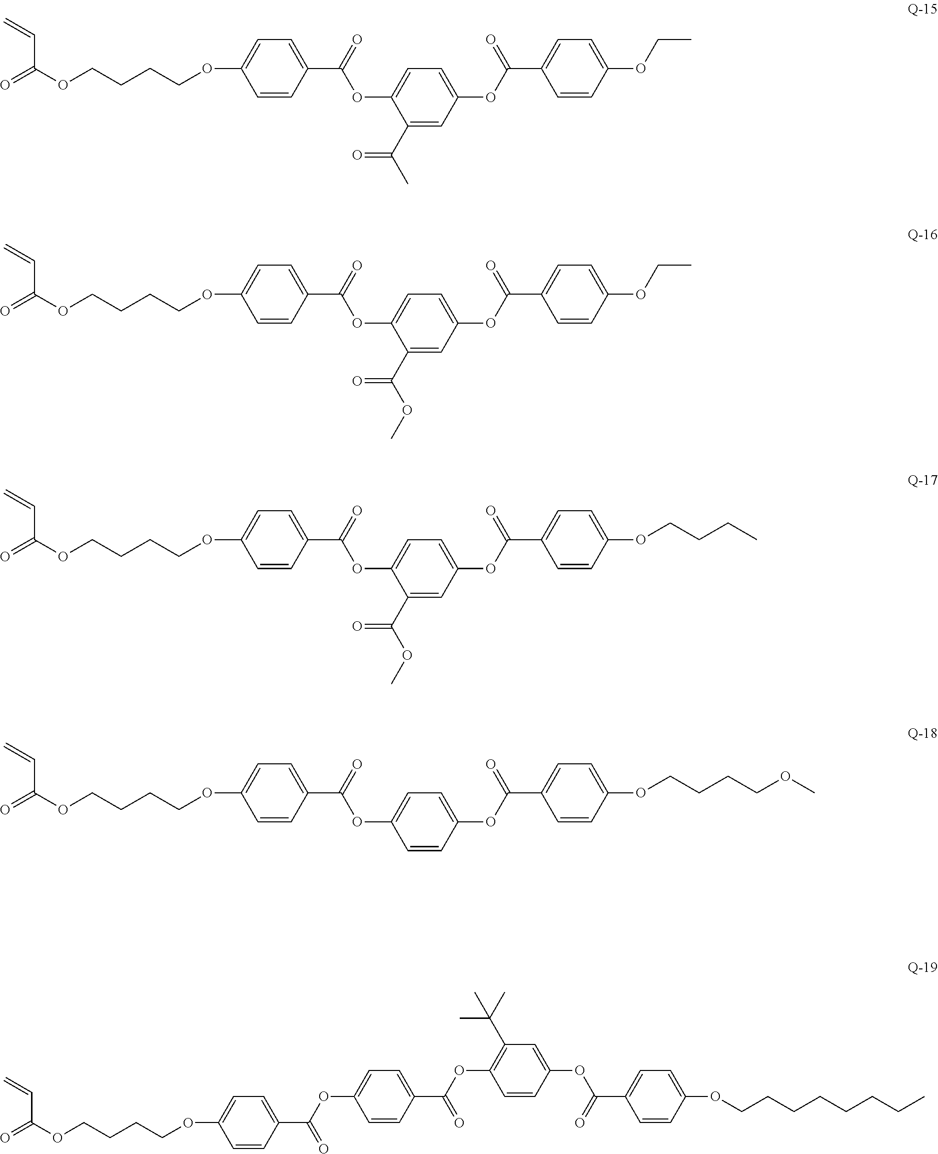

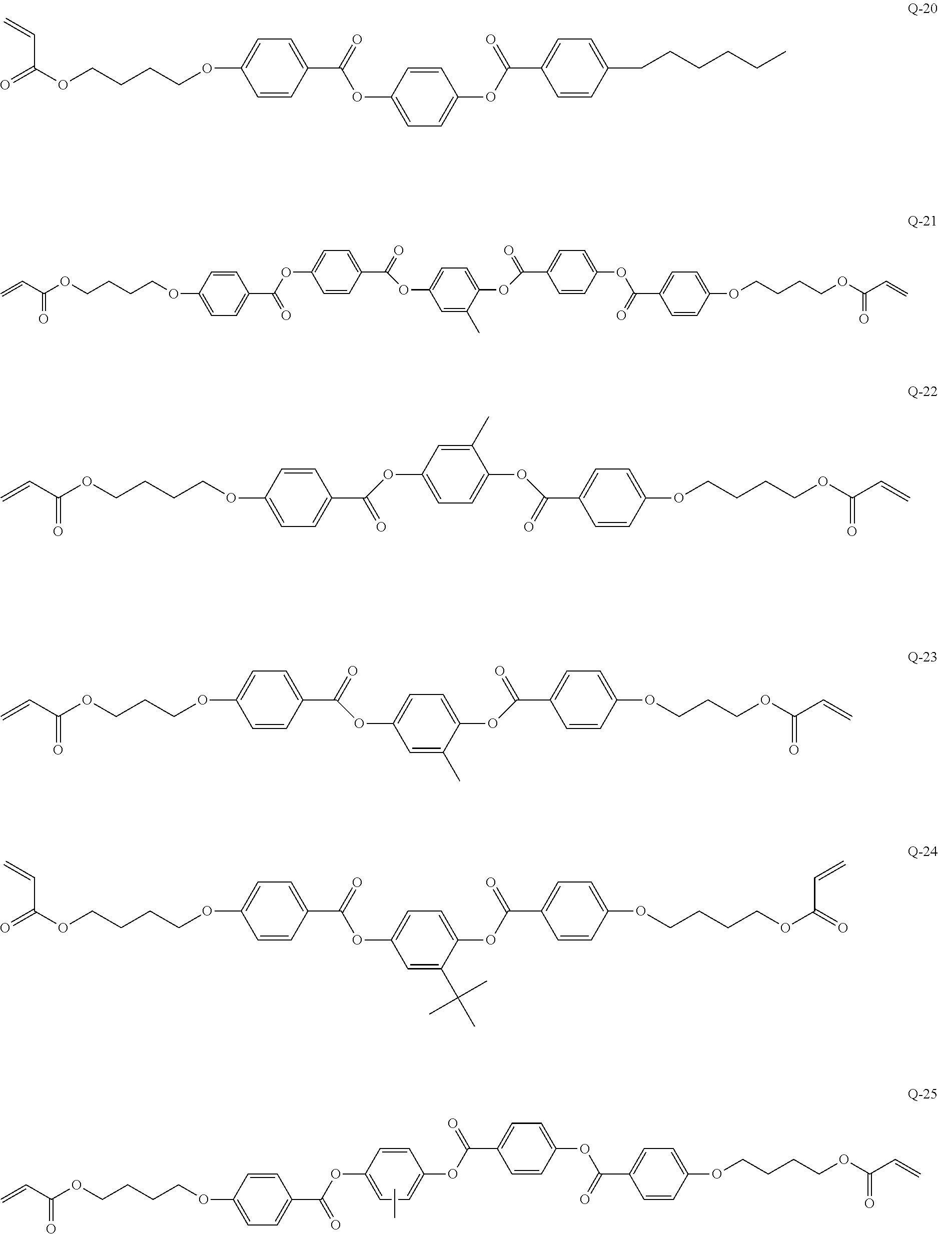

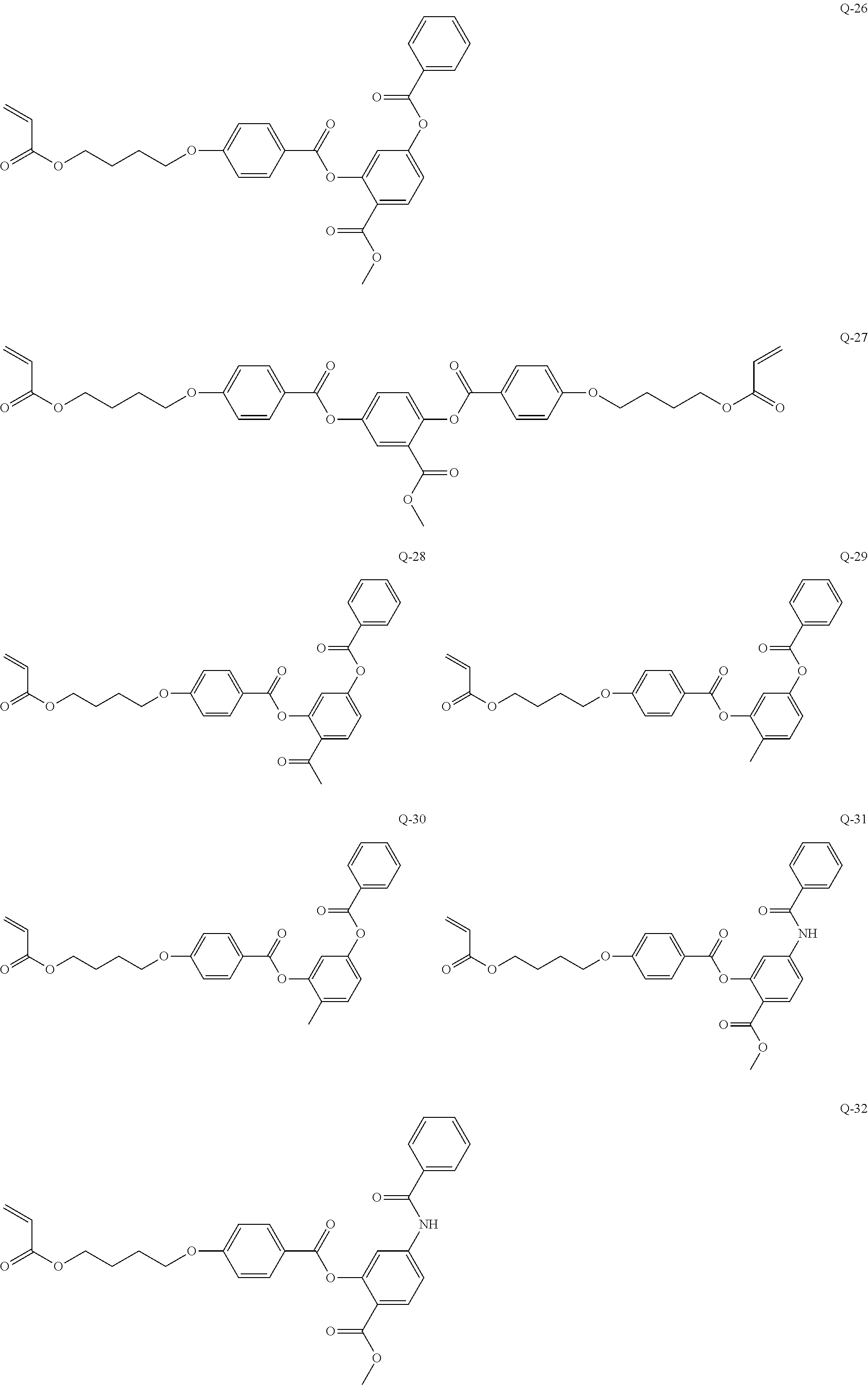

The repeating unit B may be used alone or in combination of two or more kinds thereof.

A content of the repeating unit B is preferably 5% to 60% by mass, more preferably 10% to 50% by mass, and still more preferably 15% to 45% by mass with respect to all repeating units (100% by mass) constituting the main chain of the specific leveling agent.

### (Repeating Unit C)

The repeating unit C is a repeating unit containing a reactive group.

Examples of the reactive group include a radically polymerizable group and a cationically polymerizable group, and a radically polymerizable group is preferable. Examples of the reactive group also include a functional group capable of forming a covalent bond complex with a hydroxyl group.

As the radically polymerizable group, a known radically polymerizable group can be used, and examples thereof include a vinyl group, an allyl group, a vinyloxy group, a maleimide group, an allyloxy group, a (meth)acryloyl group, a (meth)acryloyloxy group, and a (meth)acrylamide group. Among these, a (meth)acryloyl group or a (meth)acryloyloxy group is preferable.

As the cationically polymerizable group, a known cationically polymerizable group can be used, and examples thereof include an alicyclic ether group, a cyclic acetal group, a cyclic lactone group, a cyclic thioether group, a spiroorthoester group, and a vinyloxy group. Among these, an alicyclic ether group or a vinyloxy group is preferable, and an epoxy group, an oxetanyl group, or a vinyloxy group is more preferable.

As the functional group capable of forming a covalent bond complex with a hydroxyl group, a boronic acid group (—B(OH)₂) and a boronic acid ester group (—B(OR^{B1})₂) are preferable.

R^{B1}'s each independently represent a hydrogen atom, an alkyl group which may have a substituent, an aryl group which may have a substituent, or a heteroaryl group which may have a substituent, and a hydrogen atom or an alkyl group which may have a substituent is preferable.

The number of carbon atoms in the alkyl group is preferably 1 to 10 and more preferably 1 to 5.

The number of carbon atoms in the aryl group is preferably 4 to 20 and more preferably 6 to 12. Examples of the aryl group include a phenyl group.

The number of carbon atoms in the heteroaryl group is preferably 3 to 10 and more preferably 3 to 5. Examples of the heteroatom of the heteroaryl group include an oxygen atom, a nitrogen atom, and a sulfur atom.

R^{B1}'s may be bonded to each other to form a ring. The number of ring members of the ring formed by bonding R^{B1}'s to each other is preferably 4 to 8 and more preferably 5 or 6.

The number of reactive groups included in the repeating unit C is 1 or more, preferably 1 to 3 and more preferably 1 or 2.

From the viewpoint of more excellent compatibility with the liquid crystal compound, the repeating unit C is preferably a repeating unit represented by Formula (c i).

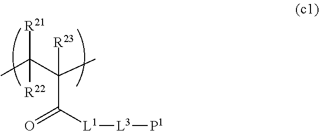

In Formula (c1), R²¹, R²², R²³, and L¹ are the same as those described in Formula (a1).

In Formula (c1), L³ represents a single bond or a divalent linking group.

Examples of the above-described divalent linking group include a divalent aliphatic hydrocarbon group having 1 to 20 carbon atoms, which may have a substituent.

The aliphatic hydrocarbon group having 1 to 20 carbon atoms is preferably an alkylene group having 1 to 15 carbon atoms and more preferably an alkylene group having 2 to 8 carbon atoms.

One or more of —CH₂—'s constituting the above-described divalent aliphatic hydrocarbon group may be each independently substituted with a group selected from —O—, -5-, —CO—, and —N(Q)-. Two or more of a plurality of —CH₂—'s may be substituted as long as the same group is not adjacent. The definition and suitable aspect of Q are as described above.

Among these, L³ is preferably an alkylene group having 2 to 8 carbon atoms, which may have a substituent, or *-(L³¹-O)ₙ₃—*, where * represents a bonding position and n3 represents an integer of 1 to 8. L³¹'s each independently represent an alkylene group having 1 to 6 carbon atoms, which may have a substituent, and an alkylene group having 2 to 4 carbon atoms, which may have a substituent, is preferable.

The divalent linking group represented by L³ may be a group including a mesogen group. As the group including a mesogen group, *—SP¹-M¹-* is preferable, where * represents a bonding position. SP¹ and M¹ are the same as those described in Formula (b1).

In a case where both a reactive group and a mesogen group are included in the repeating unit, the repeating unit corresponds to the repeating unit C.

Examples of the substituent that the above-described divalent linking group may have include a hydroxy group, a halogen atom, an amino group, an alkyl group, an alkoxy group, an acyl group, an aryl group, a nitro group, a cyano group, an alkylcarbonyl group, and a sulfonyl group.

In Formula (c1), P¹ represents a reactive group. The definition and suitable aspect of the reactive group are as described above.

Specific examples of the repeating unit C include repeating units shown below. In the following repeating units, n represents an integer of 1 or more (typically, an integer of 1 to 6).

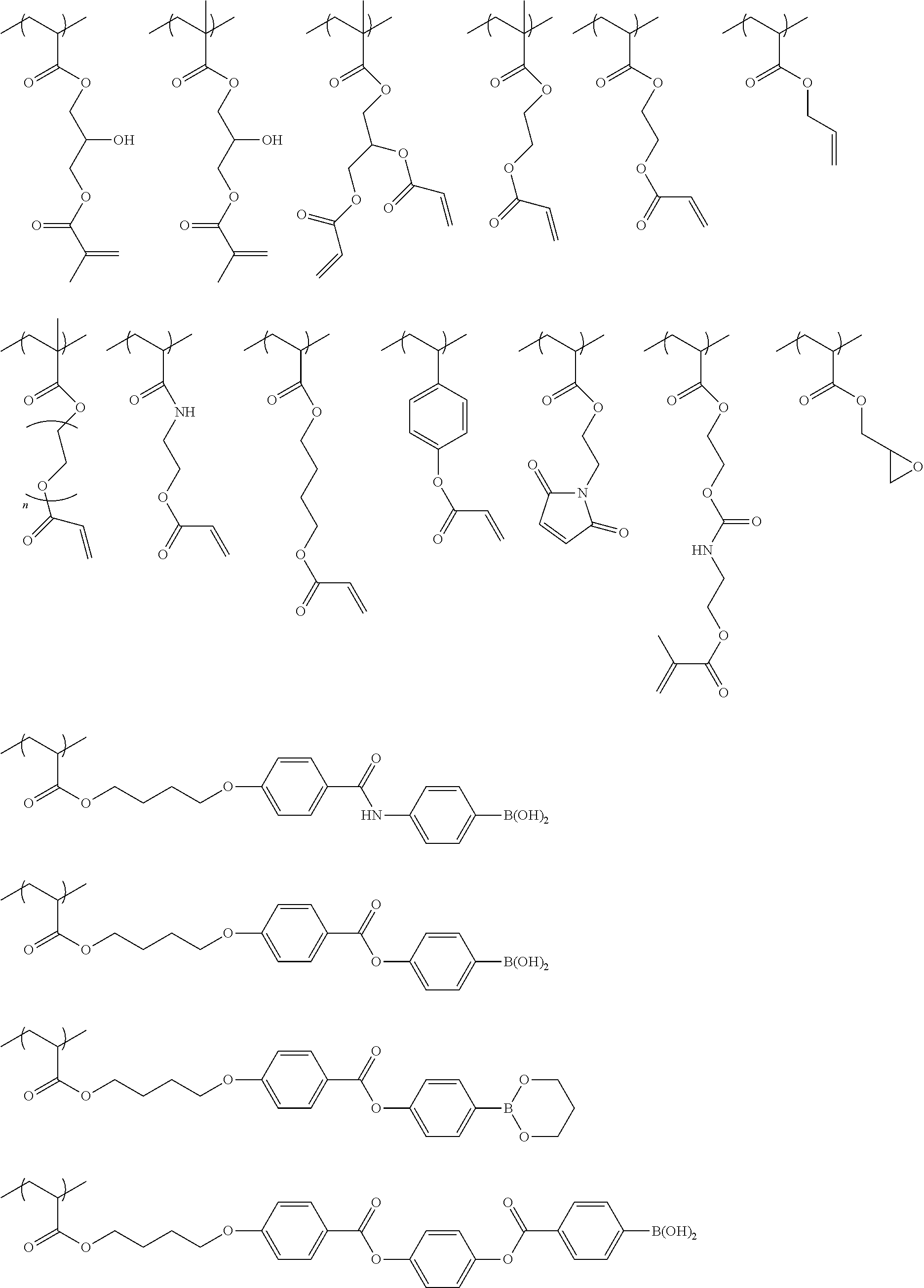

Examples of the repeating unit containing a boronic acid group or a boronic acid ester group as the reactive group also include the repeating units described in paragraphs 0036 to 0045 of WO2018/062068A.

The repeating unit C may be used alone or in combination of two or more kinds thereof.

A content of the repeating unit C is preferably 1% to 50% by mass, more preferably 5% to 25% by mass, and still more preferably 10% to 25% by mass with respect to all repeating units constituting the main chain of the specific leveling agent.

A total content of the repeating unit A, the repeating unit B, and the repeating unit C is preferably 80% by mass or more and more preferably 90% by mass or more with respect to all repeating units constituting the main chain of the specific leveling agent. The upper limit of the content of the repeating unit derived from an aromatic monomer is not particularly limited and may be 100% by mass.

### (Other Repeating Units)

The specific leveling agent may contain a repeating unit other than the above-described repeating units.

For example, the specific leveling agent may have a repeating unit containing a polar group from the viewpoint of controlling alignment. Examples of the polar group include a carboxy group, an amino group, an amide group, a urea group, a urethane group, a sulfonylamino group, a sulfo group, a phospho group, a hydroxy group, a mercapto group, a methylene group substituted with an electron withdrawing group, and a methine group substituted with an electron withdrawing group, and a carboxy group is preferable.

As the repeating unit containing a polar group, a repeating unit represented by Formula (K-1) is preferable.

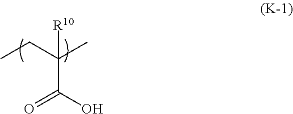

In Formula (K-1), R¹⁰ represents a hydrogen atom or an alkyl group having 1 to 20 carbon atoms, and among these, a hydrogen atom or an alkyl group having 1 to 10 carbon atoms is preferable, a hydrogen atom or an alkyl group having 1 to 4 carbon atoms is more preferable, and a hydrogen atom or a methyl group is still more preferable.

Examples of the monomer forming the repeating unit represented by Formula (K-1) include acrylic acid and methacrylic acid.

A content of the repeating unit having a polar group is preferably 0.05% to 30% by mass, more preferably 0.1% to 15% by mass, and still more preferably 1% to 10% by mass with respect to all repeating units (100% by mass) constituting the main chain of the specific leveling agent.

From the viewpoint of compatibility, it is also preferable that the specific leveling agent includes a repeating unit having a poly(alkyleneoxy) group. As the poly(alkyleneoxy) group, a group represented by *-(L³¹-O)ₙ₄—* is preferable. L³¹ is as described above in Formula (c1), and n4 represents an integer of 2 or more, preferably an integer of 2 to 60 and more preferably an integer of 4 to 40.

The poly(alkyleneoxy) group may be included in at least one repeating unit of the above-described repeating units A to C, and the specific leveling agent may include a repeating unit having a poly(alkyleneoxy) group, which is different from the repeating units A to C. Examples of the repeating unit having a poly(alkyleneoxy) group include a repeating unit derived from a (meth)acrylic acid ester containing a poly(alkyleneoxy) group.

A content of the repeating unit having a poly(alkyleneoxy) group is preferably 0.05% to 30% by mass, more preferably 1% to 30% by mass, and still more preferably 5% to 30% by mass with respect to all repeating units constituting the main chain of the specific leveling agent.

Examples of the repeating unit other than those described above include a repeating unit derived from (meth)acrylic acid alkyl (the number of carbon atoms in the alkyl group moiety is 1 to 24), a styrene derivative, (meth)acrylonitrile, a vinyl ether derivative, and an alkyl (meth)acrylamide derivative.

In a case where the specific leveling agent is a copolymer including two or more kinds of repeating units, the specific leveling agent may be any of a random copolymer, an alternating copolymer, or a block copolymer. In addition, a random, alternating, and block aspect may be mixed.

A weight-average molecular weight of the specific leveling agent is preferably 5,000 to 70,000, more preferably 9,000 to 40,000, and still more preferably 15,000 to 30,000.

Here, the weight-average molecular weight in the present invention is a value measured by a gel permeation chromatography (GPC) method under the following conditions.
Solvent (eluant): tetrahydrofuran
Apparatus name: EcoSEC HLC-8320GPC (manufactured by Tosoh Corporation)
Column: three columns of TSKgel SuperHZM-H, TSKgel SuperHZ4000, and TSKgel SuperHZ200 (all manufactured by Tosoh Corporation) are connected and used
Column temperature: 40° C.
Sample concentration: 0.1% by mass
Flow rate: 0.35 ml/min
   Calibration curve: TSK standard polystyrene (manufactured by TOSOH Corporation), calibration curves of six samples with Mw of 706,000 to 1,013 (Mw/Mn=1.03 to 1.06) are used.

The specific leveling agent may be used alone or in combination of two or more kinds thereof.

From the viewpoint that the effect of the present invention is more excellent, a content of the specific leveling agent is preferably 5% by mass or less, more preferably 1% by mass or less, and still more preferably 0.1% by mass or less with respect to the total solid content of the liquid crystal composition. In addition, from the viewpoint of leveling properties, the content of the specific leveling agent is preferably 0.001% by mass or more and more preferably 0.01% by mass or more with respect to the total solid content of the liquid crystal composition.

### <Polymerization Initiator>

It is preferable that the liquid crystal composition contains a polymerization initiator.

The polymerization initiator is not particularly limited, but a photopolymerization initiator is preferable.

As the photopolymerization initiator, a known photopolymerization initiator can be used. Examples thereof include an α-carbonyl compound, an acyloin ether, an a-hydrocarbon-substituted aromatic acyloin compound, a polynuclear quinone compound, a combination of a triarylimidazole dimer and p-aminophenyl ketone, an acridine compound, a phenazine compound, an oxadiazole compound, an o-acyloxime compound, and an acylphosphine oxide compound.

As the photopolymerization initiator, a commercially available product can also be used, and examples of the commercially available product include IRGACURE-184, IRGACURE-907, IRGACURE-369, IRGACURE-651, IRGACURE-819, IRGACURE-OXE-01, and IRGACURE-OXE-02, all of which are manufactured by BASF.

The content of the polymerization initiator is preferably 0.01% to 30% by mass, and more preferably 0.1% to 15% by mass with respect to the total solid content of the liquid crystal composition.

### <Alignment Control Agent>

The liquid crystal composition may contain an alignment control agent as necessary. The alignment control agent makes it possible to form various alignment states such as homeotropic alignment (vertical alignment), tilt alignment, hybrid alignment, and cholesteric alignment in addition to homogeneous alignment, and also makes it possible to achieve a specific alignment state more uniformly and with more precise control.

For example, a low molecular weight alignment control agent or a high molecular weight alignment control agent can be used as the alignment control agent which accelerates homogeneous alignment.

With regard to the low molecular weight alignment control agent, reference can be made to the descriptions in, for example, paragraphs [0009] to [0083] of JP2002-020363A, paragraphs [0111] to [0120] of JP2006-106662A, and paragraphs [0021] to [0029] of JP2012-211306A, the contents of which are incorporated herein by reference.

With regard to the high molecular weight alignment control agent, reference can be made to the descriptions in, for example, paragraphs [0021] to [0057] of JP2004-198511A and paragraphs [0121] to [0167] of JP2006-106662A, the contents of which are incorporated herein by reference.

Examples of the alignment control agent that forms or accelerates homeotropic alignment include a boronic acid compound and an onium salt compound, and specifically, reference can be made to the compounds described in, for example, paragraphs [0023] to [0032] of JP2008-225281A, paragraphs [0052] to [0058] of JP2012-208397A, paragraphs [0024] to [0055] of JP2008-026730A, and paragraphs [0043] to [0055] of JP2016-193869A, the contents of which are incorporated herein by reference.

On the other hand, the cholesteric alignment can be achieved by adding a chiral agent to the liquid crystal composition, and it is possible to control the direction of revolution of the cholesteric alignment by its chiral direction. Incidentally, it is possible to control a pitch of the cholesteric alignment in accordance with an alignment regulating force of the chiral agent.

### <Solvent>

From the viewpoint of workability of forming a film, it is preferable that the liquid crystal composition contains a solvent.

Examples of the solvent include organic solvents such as ketones (for example, acetone, 2-butanone, methyl ethyl ketone, methyl isobutyl ketone, cyclopentanone, and cyclohexanone), ethers (for example, dioxane, tetrahydrofuran, tetrahydropyran, dioxolane, tetrahydrofurfuryl alcohol, and cyclopentyl methyl ether), aliphatic hydrocarbons (for example, hexane), alicyclic hydrocarbons (for example, cyclohexane), aromatic hydrocarbons (for example, benzene, toluene, xylene, and trimethylbenzene), halogenated carbons (for example, dichloromethane, trichloromethane (chloroform), dichloroethane, dichlorobenzene, and chlorotoluene), esters (for example, methyl acetate, ethyl acetate, ethyl propionate, butyl acetate, and diethyl carbonate), alcohols (for example, ethanol, isopropanol, butanol, and cyclohexanol), cellosolves (for example, methyl cellosolve, ethyl cellosolve, and 1,2-dimethoxyethane), cellosolve acetates, sulfoxides (for example, dimethyl sulfoxide), amides (for example, dimethylformamide, dimethylacetamide, N-methylpyrrolidone, N-ethylpyrrolidone, and 1,3-dimethyl-2-imidazolidinone), and heterocyclic compounds (for example, pyridine), and water.

These solvents may be used alone or in combination of two or more kinds thereof.

### <Other Components>

The liquid crystal composition may contain other components as necessary, in addition to the above-described components.

Examples of the other components include a chiral agent, a chain transfer agent, a tilt angle controlling agent, a plasticizer, and a crosslinking agent.

From the viewpoint of uniformity and aligning properties, it is also preferable that the liquid crystal composition does not contain a filler (for example, silicon dioxide).

### [Manufacturing Method of Film]

The film according to the embodiment of the present invention is formed of the above-described liquid crystal composition.

It is preferable that the manufacturing method of a film according to the embodiment of the present invention includes, in the following order, a coating film forming step of applying the above-described liquid crystal composition to form a coating film, an alignment step of aligning the liquid crystal compound contained in the coating film, and an alignment fixing step of immobilizing the alignment state.

The film according to the embodiment of the present invention is preferably an optical film.

In the above-described coating film forming step, the liquid crystal composition is applied onto a substrate to form a coating film. The above-described substrate is not particularly limited, and examples thereof include a support and an alignment film, which are contained in a laminate described later. The support is easily coated with the liquid crystal composition onto the alignment film by using the liquid crystal composition containing the above-described solvent or using a liquid-like material such as a melt obtained by heating the liquid crystal composition.

Examples of the method of coating the base material with the liquid crystal composition include known methods such as a roll coating method, a gravure printing method, a spin coating method, a wire bar coating method, an extrusion coating method, a direct gravure coating method, a reverse gravure coating method, a die-coating method, a spraying method, and an inkjet method.

A method of aligning the liquid crystal compound in the above-described alignment step is not particularly limited, but preferably includes a heat treatment. From the viewpoint of manufacturing suitability and the like, a heating temperature is preferably 10° C. to 250° C. and more preferably 25° C. to 190° C. Further, the heating time is preferably 1 to 300 seconds and more preferably 1 to 60 seconds.

A cooling treatment may be performed after the above-described heat treatment. The cooling treatment is a treatment of cooling the heated coating film to room temperature (20° C. to 25° C.). The cooling unit is not particularly limited, and the cooling can be performed by a known method.

A method of immobilizing the alignment film in the above-described alignment fixing step is not particularly limited, but is preferably a step of performing at least one of a polymerization treatment or a drying treatment.

In addition, conditions for the above-described polymerization are not particularly limited, but ultraviolet rays are preferably used in the polymerization by light irradiation. An irradiation amount is preferably 10 mJ/cm² to 50 J/cm², more preferably 20 mJ/cm² to 5 J/cm², still more preferably 30 mJ/cm² to 3 J/cm², and particularly preferably 50 to 1,000 mJ/cm². In order to promote the polymerization reaction, the treatment may be performed under heating conditions.

The manufacturing method of a film according to the embodiment of the present invention preferably includes a step of performing a surface reforming treatment. Specific examples of the above-described surface reforming treatment include a corona treatment and a plasma treatment, and a corona treatment is preferable. In other words, it is preferable that the film is subjected to a corona treatment or a plasma treatment.

A timing of the surface reforming treatment is not particularly limited, but it is preferable that the surface reforming treatment is performed after the alignment fixing step.

The above-described surface reforming treatment is preferably performed on a surface of the above-described coating film on a side opposite to the substrate. In other words, it is preferable that the surface reforming treatment is performed on a surface on a side where the leveling agent is unevenly distributed.

In a case where the surface reforming treatment is performed, a bonding state of the silicon atom contained in the specific leveling agent is changed, and a binding energy of a peak top of a photoelectron spectrum of Si2p and/or an abundance of a silicon atom to which four oxygen atoms are bonded is in a more preferable aspect.

A method of the corona treatment and the plasma treatment is not particularly limited, and a known method can be adopted. For example, the corona treatment and the plasma treatment can be performed using a known corona discharge device and a known plasma treatment device.

A discharge amount in the corona treatment can be appropriately adjusted according to the composition of the film and the like, but is preferably 10 Wmin/m² or more, more preferably 50 Wmin/m² or more, and still more preferably 500 Wmin/m² or more. The upper limit thereof is not particularly limited, but is usually 5,000 Wmin/m² or less, and preferably 2,000 Wmin/m² or less.

An output and a treatment time in the corona treatment can be appropriately adjusted.

A method of the plasma treatment is not particularly limited, and a known method can be adopted. For example, the plasma treatment can be performed using a known plasma treatment device. As the plasma treatment device, for example, various devices described in paragraphs [0015] to [0058] of JP2018-170183A and paragraphs [0041] to [0074] of JP2013-056514A can be referred to, the contents of which are incorporated herein by reference.

The plasma treatment may be performed under atmospheric pressure or under reduced pressure (500 Pa or less, preferably 0 to 100 Pa).

In the plasma treatment, a gas (plasma raw material gas) to be in a plasma state is not particularly limited, and examples thereof include rare gases (inert gases) such as helium gas, neon gas, argon gas, krypton gas, xenon gas, and radon gas, oxygen gas, nitrogen gas, and hydrogen gas.

Among these, the plasma raw material gas is preferably a mixed gas containing one or more reactive gases selected from oxygen gas and nitrogen gas, and a rare gas. From the viewpoint that the water contact angle of the film surface after the plasma treatment is more likely to be reduced, a content of one or more reactive gases selected from oxygen gas and nitrogen gas in the mixed gas (in a case where both are contained, a total content thereof) is preferably 0.1% to 10.0% by volume, and more preferably 1.0% to 8.0% by volume with respect to the total volume of the mixed gas.

In addition, a content of the rare gas in the mixed gas is preferably 50.0% by volume or more, more preferably 80.0% by volume or more, and still more preferably 90.0% by volume or more with respect to the total volume of the mixed gas. The upper limit of the content of the rare gas in the mixed gas is not particularly limited, and is preferably 99.9% by volume or less, and more preferably 99.0% by mass or less with respect to the total volume of the mixed gas. The rare gas is more likely to be plasma than oxygen gas or nitrogen gas with application of lower energy. Therefore, in a case where the content of the rare gas is set to be in the above-described numerical range, discharge can be uniformly caused on the surface of the coating film, and the surface of the coating film is likely to be uniformly surface-reformed.

Among these, as the rare gas, helium gas or argon gas is preferable from the viewpoint that a metastable state is taken and discharge is likely to be sustained, and helium gas is more preferable from the viewpoint that a lifetime of an excited state is longer.

The gas composition in the plasma raw material gas can be quantified by analyzing the sampled plasma raw material gas with an analyzer such as gas chromatography and mass spectrometry.

In addition, it is preferable that the plasma treatment is performed on the surface of the coating film while transporting the coating film using a plasma generation device that is supplied with power to generate plasma between an electrode and a counter electrode.

The power in the plasma treatment is preferably 100 to 8,000 W. In particular, from the viewpoint that the water contact angle of the film can be further reduced, the power in a case of performing the plasma treatment under atmospheric pressure is more preferably 600 to 8,000 W, and still more preferably 2,500 to 6,000 W. In a case of performing the plasma treatment under reduced pressure, from the viewpoint that the water contact angle of the film can be further reduced, the power is more preferably 100 to 1,000 W, and still more preferably 100 to 500 W.

In addition, from the viewpoint of more excellent productivity and the viewpoint of discharge stability (stability of in-plane uniformity of reforming), the lower limit of the transportation speed of the coating film to be subjected to the plasma treatment is preferably 1.0 m/min or more, more preferably 3.0 m/min or more, and still more preferably 5.0 m/min or more. From the viewpoint that the influence of entrained air can be suppressed and the discharge stability (stability of in-plane uniformity of reforming) is excellent, the upper limit of the transportation speed of the coating film to be subjected to the plasma treatment is preferably 100 m/min or less, more preferably 50.0 m/min or less, still more preferably 30.0 m/min or less, even still more preferably 15.0 m/min or less, and particularly preferably less than 10.0 m/min.

The time of the plasma treatment in a case of performing the plasma treatment under atmospheric pressure is preferably 10 seconds to 10 hours, and more preferably 10 seconds to 1 hour. The time of the plasma treatment in a case of performing the plasma treatment under reduced pressure is preferably 10 seconds to 10 hours, and more preferably 10 seconds to 1 hour. In a case where the time of the plasma treatment is set to be in the above-described numerical range, problems such as the substrate being dissolved by heat and/or the electrode being deformed are less likely to occur.

The plasma treatment may be performed continuously or intermittently. In a case of being performed intermittently, the total treatment time is preferably within the above-described range.

The treatment temperature in a case of performing the plasma treatment is preferably 0° C. to 200° C., and more preferably 15° C. to 150° C.

### [Properties of Film]

The film according to the embodiment of the present invention is formed of a liquid crystal composition. Among these, as described above, it is preferable that the alignment state of the liquid crystal compound in the film is immobilized.

In the present specification, the “immobilized” state of the alignment state of the liquid crystal compound is a state in which the alignment of the liquid crystal compound is held. Specifically, the “immobilized” state is more preferably a state in which, in a temperature range of usually 0° C. to 50° C. or in a temperature range of −30° C. to 70° C. under more severe conditions, the layer has no fluidity and a fixed alignment morphology can be stably maintained without causing a change in the alignment morphology due to an external field or an external force. In the aspect of the film in which the alignment state is immobilized, the liquid crystal compound may no longer exhibit liquid crystallinity.

In the aspect of the film, the liquid crystal compound may be a polymer of a polymerizable liquid crystal compound or a polymer liquid crystal compound that is a high-molecular-weight substance in the liquid crystal composition. That is, the film may be an aspect in which the film contains a polymer of a polymerizable liquid crystal compound, and as described later, the film may be an aspect in which the film contains a polymer of a polymerizable liquid crystal compound and a component derived from a specific leveling agent.

The alignment state of the liquid crystal compound in the film according to the embodiment of the present invention may be any of a horizontal alignment state, a vertical alignment state, a tilt alignment state, or a twisted alignment state.

In addition, a plurality of alignment states may be provided in one layer as in a liquid crystal cured layer described in WO2021/033640A, having a first region in which an alignment state of a liquid crystal compound twist-aligned along a helical axis extending along a thickness direction is immobilized and a second region in which an alignment state of a homogeneously aligned liquid crystal compound is immobilized, along a thickness direction.

In the present specification, the “horizontal alignment” means that the main surface of the film and the major axis direction of the liquid crystal compound are parallel to each other. It is not required to be strictly parallel, and in the present specification, the “horizontal alignment” means that the angle between the major axis direction of the liquid crystal compound and the main surface of the film is less than 10°. In addition, in the present specification, the “vertical alignment” means that the main surface of the film and the major axis direction of the liquid crystal compound are orthogonal to each other. It is not required to be strictly vertical, and in the present specification, the “vertical alignment” means that the angle between the major axis direction of the liquid crystal compound and the main surface of the film is 170° to 110°.

The film according to the embodiment of the present invention is preferably an optically anisotropic film.

Examples of the optically anisotropic film include a positive A plate, a positive C-plate, and an optically anisotropic film having a first region in which the alignment state of a liquid crystal compound that is twisted and aligned along a helical axis extending along a thickness direction is immobilized and a second region in which the alignment state of a liquid crystal compound that is homogeneously aligned is immobilized, along the thickness direction (hereinafter, this aspect is also referred to as an “optically anisotropic film A”).

Here, the positive A-plate and the positive C-plate are defined as follows.

The positive A-plate satisfies a relationship of Expression (A1) and the positive C-plate satisfies a relationship of Expression (C1), assuming that a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz. The positive A-plate has an Rth showing a positive value and the positive C-plate has an Rth showing a negative value.

$$n x > ny \approx nz \qquad Expression ( A1 )$$

$$nz > nx \approx ny \qquad Expression ( C1 )$$

The symbol “≈” encompasses not only a case where both sides are completely the same as each other but also a case where the both sides are substantially the same as each other.

With regard to the positive A-plate, the expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”. In addition, in the positive C-plate, for example, a case where (nx−ny)×d (in which d is a thickness of a film) is 0 to 10 nm, and preferably 0 to 5 nm is also included in “nx≈ny”.

In a case where the film according to the embodiment of the present invention is the positive A plate, from the viewpoint of functioning as a λ/4 plate, Re(550) is preferably 100 to 180 nm, more preferably 120 to 160 nm, still more preferably 130 to 150 nm, and particularly preferably 130 to 145 nm.

Here, the “λ/4 plate” is a plate having a λ/4 function, specifically, a plate having a function of converting linearly polarized light having a specific wavelength into circularly polarized light (or converting circularly polarized light into linearly polarized light).

An optically anisotropic film (optically anisotropic film A) having a first region in which an alignment state of a liquid crystal compound twist-aligned along a helical axis extending along a thickness direction is fixed and a second region in which an alignment state of a homogeneously aligned liquid crystal compound is fixed, along the thickness direction, will be described in detail.

In a case where the thickness of the first region of the optically anisotropic film is defined as d1 (nm) and the refractive index anisotropy of the first region measured at a wavelength of 550 nm is defined as Δn1, from the viewpoint that an optically anisotropic film can be suitably applied to a circular polarization plate, the first region preferably satisfies Expression (1-1).

$$100 nm \leq Δ n 1 d 1 \leq 240 nm \qquad Expression ( 1 - 1 )$$

Among these, it is more preferable that the first region satisfies the following expression (1-2), and it is still more preferable that the first region satisfies the following expression (1-3).

$$120 nm \leq Δ n 1 d 1 \leq 220 nm \qquad Expression ( 1 - 2 )$$

$$140 nm \leq Δ n 1 d 1 \leq 200 nm \qquad Expression ( 1 - 3 )$$

It is noted that the refractive index anisotropy Δn1 means a refractive index anisotropy of the first region.

The absolute value of the twisted angle of the liquid crystal compound in the first region is not particularly limited and is preferably 600 to 1200 and more preferably 700 to 1100 from the viewpoint that an optically anisotropic film can be suitably applied to a circular polarization plate. The twisted angle is measured using Axoscan of Axometrics, Inc. and using device analysis software of Axometrics, Inc.

In addition, in a case where the thickness of the second region of the optically anisotropic film A is defined as d2 (nm) and the refractive index anisotropy of the second region measured at a wavelength of 550 nm is defined as Δn2, from the viewpoint that an optically anisotropic film can be suitably applied to a circular polarization plate, the second region preferably satisfies Expression (2-1).

$$100 nm \leq Δ n 2 d 2 \leq 240 nm \qquad Expression ( 2 - 1 )$$

Among these, it is more preferable that the second region satisfies the following expression (2-2), and it is still more preferable that the second region satisfies the following expression (2-3).

$$120 nm \leq Δ n 2 d 2 \leq 220 nm \qquad Expression ( 2 - 2 )$$

$$140 nm \leq Δ n 2 d 2 \leq 200 nm \qquad Expression ( 2 - 3 )$$

The refractive index anisotropy Δn2 means a refractive index anisotropy of the second region.

The film according to the embodiment of the present invention contains a silicon atom derived from the specific leveling agent. A form of the silicon atom is not particularly limited, and the silicon atom may be contained as a part of the specific leveling agent described above or may be contained in another aspect. As another aspect, the film may be an aspect in which the film contains a component derived from the specific leveling agent (for example, silicon dioxide described later).

From the viewpoint that the effect of the present invention is more excellent, it is also preferable that the silicon atom is contained in a form of silicon dioxide. The presence of silicon dioxide can be determined, for example, by presence or absence of a fragment having a molecular weight corresponding to (SiO₂)ₗ (l is an integer of 1 or more) in a case where time of flight secondary ion mass spectrometry (TOF-SIMS) is performed on the film.

A thickness of the film according to the embodiment of the present invention is not particularly limited, but is preferably 0.1 to 10 μm and more preferably 0.5 to 5 μm.

### <Requirement 1>

The film according to the first aspect satisfies the following requirement 1.

Requirement 1: in a photoelectron spectrum of Si2p obtained by measuring a surface of the film with X-ray photoelectron spectroscopy (XPS), a binding energy of a peak top is 102.0 eV or more.

In the film according to the first aspect, it is sufficient that at least one surface satisfies the requirement 1, and in the above-described manufacturing method of a film, it is preferable that a surface on an air interface side of a coating film formed of the liquid crystal composition satisfies the above-described requirement.

From the viewpoint that the effect of the present invention is more excellent, the binding energy of the peak top of the photoelectron spectrum of Si2p is preferably 102.5 eV or more and more preferably 103.2 eV or more. The binding energy of the peak top of the photoelectron spectrum of Si2p is 105.0 eV or less in many cases, and 104.0 eV or less in more cases.

The photoelectron spectrum of Si2p measured by XPS is a core-level photoelectron spectrum corresponding to a 2p orbital of a silicon atom (Si).

A specific measuring method of the photoelectron spectrum of Si2p is as follows.

First, the surface of the film is measured under the following conditions to obtain a photoelectron spectrum of Si2p. A spectrum in which a peak top is observed in a range of 101.0 to 106.0 eV is attributed to the photoelectron spectrum of Si2p.

### (XPS Measurement Conditions)

Apparatus: Quantera manufactured by ULVAC-PHI, INCORPORATED
X-ray source: monochromatized Al-Kα ray (X-ray beam diameter: 100 mΦ, output: 25 W, voltage: 15 kV)
Analysis area: 300 m×300 m
Pass Energy: 55 eV
Step energy: 0.05 eV
Electrical charge correction: Yes (an electron gun and a low-speed ion gun are used in combination)
Photoelectron take-off angle: 45

In the above-described measurement, the calibration of the binding energy is performed by setting the peak top of the photoelectron spectrum of C1s derived from a C—C bond detected from the same sample to 284.8 eV.

### <Requirement 2>

The film according to the second aspect satisfies the following requirement 2.

Requirement 2: A silicon atom to which four oxygen atoms are bonded is present on a surface of the film.

In the film according to the second aspect, it is sufficient that at least one surface satisfies the requirement 2, and in the above-described manufacturing method of a film, it is preferable that the surface on the air interface side of the coating film formed of the liquid crystal composition satisfies the above-described requirement.

The presence of the silicon atom to which four oxygen atoms are bonded can be confirmed by XPS.

Specifically, the presence or absence of the silicon atom to which four oxygen atoms are bonded can be confirmed by the presence or absence of a peak attributed to the silicon atom in the photoelectron spectrum of Si2p measured by XPS in the same procedure as in the above-described requirement 1.

A method of confirming the peak attributed to the silicon atom to which four oxygen atoms are bonded will be described.

The photoelectron spectrum of Si2p is fitted using values of four binding energies of a first peak to a fourth peak shown below. The first peak is attributed to SiO_1, the second peak is attributed to SiO_2, the third peak is attributed to SiO_3, and the fourth peak is attributed to SiO_4. SiO_n (n=1, 2, 3, and 4) represents a silicon atom having n Si-O bonds and (4−n) Si—C bonds. SiO_4 corresponds to the silicon atom to which four oxygen atoms are bonded.

Specifically, the binding energy of the peak top of each of the first peak to the fourth peak is fixed in a range of each value shown below ±0.1 eV, the fitting function is a Gaussian-Lorentz function (Gaussian ratio is 90% or more), the baseline is processed using the Shirley method, and the fitting is performed such that the residual sum of squares with the actually measured spectrum is minimized.
First peak (SiO_1): 101.62 eV
Second peak (SiO_2): 102.15 eV
Third peak (SiO_3): 102.65 eV
Fourth peak (SiO_4): 103.33 eV

From the obtained fitting results, in a case where the fourth peak is present, the silicon atom to which four oxygen atoms are bonded is present.

The presence of the fourth peak means that the area of the fourth peak is 4% or more with respect to the area of the photoelectron spectrum of Si2p. The area of the fourth peak is preferably 30% or more and more preferably 97% or more with respect to the area of the photoelectron spectrum of Si2p. The upper limit of the area of the fourth peak is not particularly limited, and may be 100% with respect to the area of the photoelectron spectrum of Si2p.

### <Silicon Atom Amount>

From the viewpoint that the present invention is more excellent, the content of the silicon atom on the surface of the film according to the embodiment of the present invention is preferably 15.0 Atomic % or less and more preferably 5.0 Atomic % or less with respect to all atoms on the film surface. In addition, from the viewpoint that the leveling properties and the effects of the present invention are more excellent, the content of the silicon atom on the surface of the film according to the embodiment of the present invention is preferably 1.0 Atomic % or more and more preferably 1.5 Atomic % or more with respect to all atoms on the film surface.

The content of the silicon atom is a value measured by the above-described XPS. Specifically, XPS is performed in the same procedure as in the above-described requirement 1, the atomic concentration of all the detected atoms is calculated, and the content (Atomic %) of the silicon atom with respect to all the detected atoms is calculated.

It is preferable that the surface satisfying any one of the above-described requirement 1 or requirement 2 satisfies the above-described requirement. In this case, the other surface may not satisfy the above-described requirement.

### <Water Contact Angle>

The water contact angle of the surface of the film according to the embodiment of the present invention is preferably 80° or less, more preferably 70° or less, and still more preferably 50° or less. In addition, the water contact angle of the film according to the embodiment of the present invention is often 10° or more, and is preferably 20° or more.

It is preferable that the surface satisfying any one of the above-described requirement 1 or requirement 2 satisfies the above-described requirement. In this case, the other surface may not satisfy the above-described requirement.

The above-described water contact angle can be measured by a known method, and for example, can be measured at 25° C. using DMo-702 manufactured by Kyowa Interface Science Co., Ltd.

### <Surface Elastic Modulus>

The surface elastic modulus of the film according to the embodiment of the present invention is preferably 2.5 GPa or more, more preferably 4.0 GPa or more, and still more preferably 5.1 GPa or more. The upper limit of the surface elastic modulus of the film according to the embodiment of the present invention is not particularly limited, but is often 10.0 GPa or less, and is preferably 7.0 GPa or less.

It is preferable that the surface satisfying any one of the above-described requirement 1 or requirement 2 satisfies the above-described requirement. In this case, the other surface may not satisfy the above-described requirement.

The surface in the above-described surface elastic modulus is intended to be a region from the air interface of the film to 20 nm or less.

The above-described surface elastic modulus can be measured on the surface of the film using an atomic force microscopy (AFM).

Specifically, the surface elastic modulus can be calculated by performing fitting according to a JKR contact mechanics model on a load/displacement curve obtained by performing measurement in a QNM mode using an AFM device. As the AFM, for example, Dimension Icon (manufactured by Bruker) can be used. The details of the specific procedure will be described in detail in Examples later.

### <Surface Adsorption Force>

The surface adsorption force of the film according to the embodiment of the present invention is preferably 9.5 nN or more, more preferably 12.0 nN or more, and still more preferably 20.0 nN or more. In addition, the upper limit of the surface adsorption force of the film according to the embodiment of the present invention is not particularly limited, but is usually 50.0 nN or less, preferably 40.0 nN or less, and more preferably 30.0 nN or less.

It is preferable that the surface satisfying any one of the above-described requirement 1 or requirement 2 satisfies the above-described requirement. In this case, the other surface may not satisfy the above-described requirement.

The above-described surface adsorption force can be measured on the surface of the film using an AFM.

Specifically, the surface adsorption force can be calculated by performing fitting according to a JKR contact mechanics model on a load/displacement curve obtained by performing measurement in a QNM mode using an AFM device. The details of the specific procedure will be described in detail in Examples later.

### [Laminate]

The film according to the embodiment of the present invention can be used as a laminate combined with another layer.

Examples of the other layer in the laminate including the film according to the embodiment of the present invention (hereinafter, also referred to as “laminate according to the embodiment of the present invention”) include a support and an alignment film. In the above-described laminate, it is also preferable that the other layer is laminated such that the surface of the film satisfying at least one of the above-described requirement 1 or requirement 2 is the outermost surface.

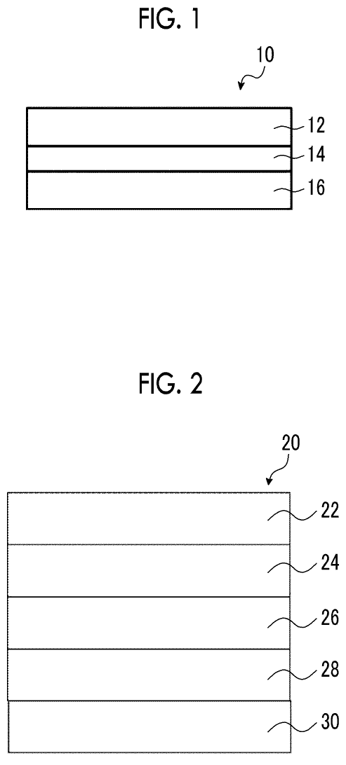

FIG. 1 is a schematic cross-sectional view showing an example of the laminate according to the embodiment of the present invention. FIG. 1 is a schematic view, and the thickness, the positional relationship, and the like of each layer do not necessarily match the actual ones, and both the support and the alignment film shown in FIG. 1 are optional constituent members.

A laminate 10 shown in FIG. 1 includes a support 16, an alignment film 14, and a liquid crystal layer 12 in this order. The liquid crystal layer 12 is the film according to the embodiment of the present invention.

In addition, the liquid crystal layer 12 may be an optically anisotropic layer. In addition, another liquid crystal layer may be provided between the liquid crystal layer 12 and the alignment film 14. For example, in a case where a polarizing plate according to the embodiment of the present invention described later is used as a circular polarization plate, or in a case where the film according to the embodiment of the present invention is used as an optical compensation film for an in-plane switching (IPS) mode or fringe-field-switching (FFS) mode liquid crystal display device, it is preferable that the laminate includes a positive A-plate and a positive C-plate.

Hereinafter, various members used in the laminate according to the embodiment of the present invention will be described in detail.

### <Support>

The support is a substrate for forming a film.

The support is preferably transparent. Specifically, a light transmittance thereof is preferably 80% or more.

Examples of the support include a glass substrate and a polymer film. Examples of the material for the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers made by mixing these polymers.

In addition, an aspect in which a polarizer described later may also function as the support is also adopted.

The thickness of the support is not particularly limited and is preferably 5 to 100 μm, and more preferably 5 to 50 μm. It is preferable that the support is peelable.

### <Alignment Film>

The laminate according to the embodiment of the present invention preferably has an alignment film between the support and the film. An aspect in which the above-mentioned support also serves as the alignment film may be adopted.

The alignment film generally contains a polymer as a main component. The polymer material for the alignment film is described in many publications, and many commercially available products are available.

The polymer material used in the present invention is preferably a polyvinyl alcohol, a polyimide, or a derivative thereof. In particular, a modified or non-modified polyvinyl alcohol is preferable.

Examples of the alignment film that can be used in the present invention include the alignment films described in line 24 on page 43 to line 8 on page 49 of WO01/088574A; the modified polyvinyl alcohols described in paragraphs [0071] to [0095] of JP3907735B; and the liquid crystal alignment films formed by a liquid crystal aligning agent, described in JP2012-155308A.

In the present invention, for the reason that it is possible to prevent deterioration in the surface condition by not coming into contact with the surface of the alignment film during the formation of the alignment film, it is also preferable to use a photo-alignment film as the alignment film.

The photo-alignment film is not particularly limited, and polymer materials such as a polyamide compound and a polyimide compound, described in paragraphs [0024] to [0043] of WO2005/096041A; liquid crystal alignment films formed by a liquid crystal aligning agent having a photo-aligned group with a cinnamic acid structure, described in JP2012-155308A; a trade name LPP-JP265CP manufactured by Rolic Technologies Ltd.; or the like can be used.

In addition, in the present invention, a thickness of the above-described alignment film is not particularly limited, but from the viewpoint of forming an optically anisotropic layer having a homogeneous film thickness by alleviating the surface roughness which can be present on the support, it is preferably 0.01 to 10 μm, more preferably 0.01 to 1 μm, and still more preferably 0.01 to 0.5 km.

In the laminate according to the embodiment of the present invention, the film according to the embodiment of the present invention may be formed on the surface of another liquid crystal layer.

The other liquid crystal layer may be a liquid crystal layer obtained by immobilizing the above-described liquid crystal composition in a predetermined alignment state, or may be a liquid crystal layer obtained by immobilizing a composition including a liquid crystal compound and optionally an optional component (for example, a polymerization initiator, a dichroic substance, and a leveling agent) in a predetermined alignment state.

In the laminate according to the embodiment of the present invention, the film according to the embodiment of the present invention may be laminated with another liquid crystal layer.

In a case where the film according to the embodiment of the present invention is laminated with another liquid crystal layer, it is also preferable that the film according to the embodiment of the present invention is laminated with the other liquid crystal layer through an adhesive layer. In other words, it is also preferable that the laminate according to the embodiment of the present invention includes an adhesive layer. As described above, the liquid crystal layer (particularly, the surface where the leveling agent is unevenly distributed) formed of the liquid crystal composition including the leveling agent including a silicon atom may not have sufficient adhesiveness to the adjacent layer, but the film according to the embodiment of the present invention satisfies at least one of the above-described requirement 1 or the above-described requirement 2, and thus exhibits excellent adhesiveness even in a case where the surface side where the leveling agent is unevenly distributed and the adhesive layer are adjacent to each other.

The other liquid crystal layer may be the film according to the embodiment of the present invention or the above-described other liquid crystal layer.

The above-described adhesive layer is a layer formed of an adhesive. The adhesive layer is preferably a curable adhesive composition which is cured by irradiation with active energy rays or by heating.

Examples of the curable adhesive include an electron beam-curable adhesive, an ultraviolet curable adhesive, and a visible ray-curable adhesive, and an ultraviolet curable adhesive is preferable.

Examples of the curable adhesive composition include a curable adhesive composition containing a cationically polymerizable compound (for example, an epoxy-based adhesive) and a curable adhesive composition containing a radically polymerizable compound (for example, a (meth)acrylate-based adhesive).

With regard to the adhesive layer, reference can be made to, for example, the description in paragraphs [0062] to [0080] of JP2016-035579A, the contents of which are incorporated herein by reference.

In consideration of the influence of external light (particularly, ultraviolet rays), it is also preferable that the laminate according to the embodiment of the present invention includes an ultraviolet (UV) absorber.

The ultraviolet absorber may be contained in the film according to the embodiment of the present invention or may be contained in a member other than the film. Suitable examples of the member other than the film include a support.

As the ultraviolet absorber, any one of ultraviolet absorbers known in the related art, which can express ultraviolet absorptivity, can be used. Among such ultraviolet absorbers, it is preferable to use a benzotriazole-based ultraviolet absorber or a hydroxyphenyltriazine-based ultraviolet absorber, from the viewpoint of achieving a high ultraviolet absorptivity and obtaining an ultraviolet absorbing ability (ultraviolet-shielding ability) for use in an image display device.

In addition, in order to broaden the absorption width of ultraviolet rays, two or more types of ultraviolet absorbers having different maximum absorption wavelengths can be used in combination.

Specific examples of the ultraviolet absorber include the compounds described in paragraphs [0258] and [0259] of JP2012-018395A and the compounds described in paragraphs [0055] to [0105] of JP2007-072163A.

In addition, for example, Tinuvin 400, Tinuvin 405, Tinuvin 460, Tinuvin 477, Tinuvin 479, and Tinuvin 1577 (all manufactured by BASF SE) can be used as a commercially available product of the ultraviolet absorber.

### [Polarizing Plate]

The polarizing plate according to the embodiment of the present invention includes a polarizer, an adhesive layer, and the film according to the embodiment of the present invention.

In a case where the film according to the embodiment of the present invention is a positive A plate, from the viewpoint that the film can be suitably applied to a circular polarization plate or the like, an angle between a slow axis of the positive A plate and an absorption axis of a polarizer described later is preferably 30° to 60°, more preferably 40° to 50°, still more preferably 42° to 48°, and particularly preferably 45°.

Here, the “slow axis” means a direction in which the in-plane refractive index of the liquid crystal layer is maximized, and the “absorption axis” of the polarizer means a direction in which the absorbance is the highest.

In a case where the film according to the embodiment of the present invention is the above-described optically anisotropic film A, from the viewpoint that the optically anisotropic film A can be suitably applied to a circular polarization plate or the like, an absolute value of an angle between an in-plane slow axis of the second region, in which the alignment state of the homogeneously aligned liquid crystal compound is fixed, and the absorption axis of the polarizer is preferably 5° to 25° and more preferably 10° to 20°.

In addition, the polarizing plate can also be used as an optical compensation film of an IPS or FFS type liquid crystal display device.

In a case where the polarizing plate is used as an optical compensation film of an IPS or FFS type liquid crystal display device, it is preferable that the above-described film according to the embodiment of the present invention is used as at least one plate of a laminate of a positive A-plate and a positive C-plate. In other words, it is preferable that the polarizing plate according to the embodiment of the present invention includes a polarizer, an adhesive layer, the film according to the embodiment of the present invention, and a liquid crystal layer, and one of the film according to the embodiment of the present invention or the liquid crystal layer is a positive A-plate and the other is a positive C-plate. The above-described liquid crystal layer may also correspond to the film according to the embodiment of the present invention. It is preferable that the angle between the slow axis of the positive A plate layer and the absorption axis of the polarizer described later is orthogonal or parallel, and specifically, the angle between the slow axis of the positive A plate layer and the absorption axis of the polarizer described later is more preferably 0° to 5° or 85° to 95°.

In a case where the polarizing plate according to the embodiment of the present invention is used in an image display device described later, it is preferable that the angle between the slow axis of the liquid crystal layer and the absorption axis of the polarizer described later is parallel or orthogonal.

The polarizing plate according to the embodiment of the present invention may include a closely attached layer between the polarizer and the film according to the embodiment of the present invention, and the closely attached layer may be an adhesive layer.

In a case where the polarizer according to the embodiment of the present invention includes a laminate of a positive A-plate and a positive C-plate, it is preferable that an adhesive layer is provided between the positive A-plate and the positive C-plate.

FIG. 2 is a schematic cross-sectional view showing an example of the polarizing plate of an embodiment of the present invention. A polarizing plate 20 shown in FIG. 2 includes a polarizer 22, a first closely attached layer 24, a first liquid crystal layer 26, a second closely attached layer 28, and a second liquid crystal layer 30 in this order. FIG. 2 is a schematic view, and the thickness, the positional relationship, and the like of each layer do not necessarily match the actual ones. In addition, one of the first closely attached layer 24 and the second closely attached layer 28 is an optional member, and one of the first liquid crystal layer and the second liquid crystal layer is an optional member.

In the polarizing plate of the aspect shown in FIG. 2, at least one of the first liquid crystal layer 26 or the second liquid crystal layer 30 is the film according to the embodiment of the present invention, and it is preferable that at least the first liquid crystal layer 26 is the film according to the embodiment of the present invention. In addition, it is preferable that the first liquid crystal layer 26 and the second liquid crystal layer 30 are a positive A plate and a positive C-plate, respectively.

In the polarizing plate of the aspect shown in FIG. 2, at least one of the first closely attached layer 24 or the second closely attached layer 28 is an adhesive layer, and it is preferable that at least the second closely attached layer 28 is an adhesive layer.

### [Polarizer]

The polarizer is not particularly limited as long as it is a member having a function of converting light into specific linearly polarized light. An absorption-type polarizer, a reflective-type polarizer, or a coating-type polarizer which has been known can be used.

As the absorption type polarizer described above, an iodine-based polarizer, a dye-based polarizer using a dichroic dye, a polyene-based polarizer, or the like is used. Iodine-based polarizers and dye-based polarizers include coating type polarizers and stretch type polarizers, and any of these can be applied. However, a polarizer produced by adsorbing iodine or a dichroic dye onto polyvinyl alcohol and stretching the polyvinyl alcohol is preferable.

Examples of the coating type polarizer include a polarizer containing a cured product of a liquid crystal compound and a dichroic coloring agent.

As the reflective type polarizer, a polarizer obtained by laminating thin films having different birefringences, a wire grid type polarizer, a polarizer obtained by combining a cholesteric liquid crystal having a selective reflection range with a ¼ wavelength plate, or the like is used.

The thickness of the polarizer is not particularly limited and is preferably 3 to 60 μm, more preferably 3 to 30 μm, and still more preferably 3 to 10 μm.

### [Adhesive Layer]

The polarizing plate according to the embodiment of the present invention includes an adhesive layer.

The polarizing plate according to the embodiment of the present invention may include an adhesive layer between the polarizer and the film according to the embodiment of the present invention, may include an adhesive layer between any one of the polarizer or the film according to the embodiment of the present invention and another layer (for example, a liquid crystal layer), or may include an adhesive layer between any layers. The adhesive layer is preferably adjacent to the film according to the embodiment of the present invention. Among these, the adhesive layer is preferably adjacent to the surface satisfying the requirement 1 of the film according to the first aspect or adjacent to the surface satisfying the requirement 2 of the film according to the second aspect.

Examples of the adhesive layer include the above-described adhesive layer.

The thickness of the adhesive layer is preferably 0.01 to 20 μm, more preferably 0.01 to 10 μm, and still more preferably 0.05 to 5 μm. In a case where the thickness of the closely attached layer is within the above-described range, there is no problem in practical use because the closely attached layer does not cause floating or peeling between the film to be laminated and the polarizer, and a sufficient adhesive force can be obtained. In addition, from the viewpoint of suppressing the generation of air bubbles, the thickness of the closely attached layer is preferably 0.4 μm or more.

The polarizing plate according to the embodiment of the present invention may include a pressure sensitive adhesive layer as the closely attached layer. For example, the polarizing plate according to the embodiment of the present invention may include an adhesive layer between the film according to the embodiment of the present invention and another liquid crystal layer, and may include a pressure sensitive adhesive layer between the polarizer and the polarizing plate according to the embodiment of the present invention.

Examples of the pressure sensitive adhesive contained in the pressure sensitive adhesive layer include an acrylic pressure sensitive adhesive, an epoxy-based pressure sensitive adhesive, a rubber-based pressure sensitive adhesive, a silicone-based pressure sensitive adhesive, a urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive.

Among these, from the viewpoint of excellent transparency, weather fastness, heat resistance, and the like, an acrylic pressure sensitive adhesive (pressure-sensitive adhesive) is preferable.

With regard to the pressure sensitive adhesive, reference can be made to paragraphs [0071] to [0084] of JP2018-060014A, the contents of which are incorporated herein by reference.

The thickness of the pressure sensitive adhesive layer is preferably 0.01 to 20 μm, more preferably 0.01 to 10 μm, and still more preferably 0.05 to 5 μm. In a case where the thickness of the pressure sensitive adhesive layer is within the above-described range, there is no problem in practical use because the pressure sensitive adhesive layer does not cause floating or peeling during lamination, and a sufficient adhesive force can be obtained.

### [Image Display Device]

The display device according to the embodiment of the present invention is an image display device including the film according to the embodiment of the present invention or the polarizing plate according to the embodiment of the present invention.

A display element used in the image display device is not particularly limited, and examples thereof include a liquid crystal cell, an organic electroluminescent (hereinafter, simply referred to as “EL”) display panel, and a plasma display panel. Among these, a liquid crystal cell or an organic EL display panel is preferable. That is, the image display device according to the embodiment of the present invention is preferably a liquid crystal display device using a liquid crystal cell as a display element or an organic EL display device using an organic EL display panel as a display element.

### [Organic EL Display Device]

Examples of the organic EL display device, which is an example of the image display device, include an aspect in which a polarizer, a V/4 plate consisting of the above-described film, and an organic EL display panel are provided in this order from the viewing side.

In addition, the organic EL display panel is a display panel configured using an organic EL element which has an organic light emitting layer (organic electroluminescence layer) sandwiched between electrodes (between a cathode and an anode). The configuration of the organic EL display panel is not particularly limited, and a known configuration is employed.

### [Liquid Crystal Display Device]

A liquid crystal display device as an example of the image display device is a liquid crystal display device including the above-described polarizing plate and a liquid crystal cell.

Of the polarizing plates provided on both sides of the liquid crystal cell, it is preferable to use the above-mentioned polarizing plate as a polarizing plate on the front side, and it is more preferable to use the above-mentioned polarizing plate as polarizing plates on the front and rear sides.

### <Liquid Crystal Cell>

The liquid crystal cell used in the liquid crystal display device is preferably in a vertical alignment (VA) mode, an optically compensated bend (OCB) mode, an in-plane-switching (IPS) mode, a fringe-field-switching (FFS) mode, or a twisted nematic (TN) mode, but is not limited thereto.

### EXAMPLES

Hereinbelow, the present invention will be described in more detail with reference to Examples.

The material, the amount used, the proportion, the process contents, the process procedure, and the like shown in the following examples can be appropriately changed, within a range not departing from the gist of the present invention. Therefore, the scope of the present invention should not be construed as being limited to Examples shown below.

### [Production of Film and Laminate]

A film and a laminate according to the embodiment of the present invention were produced as follows.

### [Production of Support (Cellulose Acylate Dope)]

The following composition was put into a mixing tank, stirred, and heated at 90° C. for 10 minutes. Thereafter, the obtained composition was filtered through a filter paper having an average hole diameter of 34 μm and a sintered metal filter having an average hole diameter of 10 μm to prepare a dope. The concentration of solid contents of the dope was 23.5% by mass, the addition amount of the plasticizer was the ratio to the cellulose acylate, and the solvent of the dope was methylene chloride/methanol/butanol=81/18/1 (mass ratio).

Cellulose acylate dope

| | | |
|---|---|---|
| Cellulose acylate | 100 | parts by mass |
| (acetyl substitution degree of 2.86, | | |
| viscosity average polymerization | | |
| degree of 310): | | |
| Sugar ester compound 1 (Formula (S4) | 6.0 | parts by mass |
| shown below) | | |
| Sugar ester compound 2 (Formula (S5) | 2.0 | parts by mass |
| shown below) | | |
| Silica particle dispersion liquid | 0.1 | parts by mass |
| (AEROSIL R972, manufactured by | | |
| Nippon Aerosil Co., Ltd.) | | |
| Solvent (methylene chloride/ | 351.9 | parts by mass |
| methanol/butanol) | | |

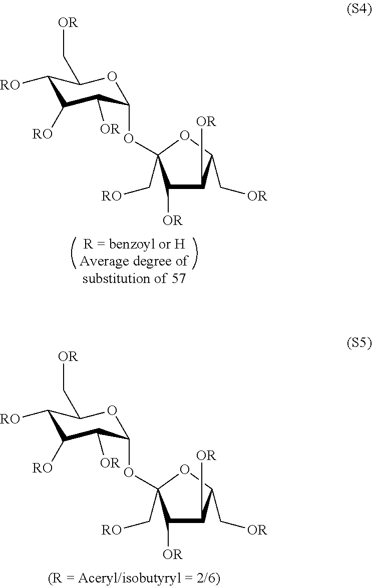

The prepared dope above was cast using a drum film-forming machine. The dope was cast from a die such that the dope was in contact with a metal support cooled to 0° C., and then the obtained web (film) was stripped. The drum was made of Steel Use Stainless (SUS).

The web (film) obtained by casting was peeled off from the drum and dried in a tenter device for 20 minutes using a tenter device such that both ends of the web were clipped with clips and transported at 30° C. to 40° C. during film transport. Subsequently, the web was post-dried by zone heating while being rolled and transported. The obtained web was subjected to knurling and then wound to obtain a cellulose acylate film Al.

In the obtained cellulose acylate film, a film thickness was 40 μm, an in-plane retardation Re(550) at a wavelength of 550 nm was 1 nm, and a thickness direction retardation Rth(550) at a wavelength of 550 nm was 25 nm.

### [Production of Laminate F1-1]

### <Formation of Alignment Film>

The above-described cellulose acylate film A1 was continuously coated with a coating liquid E1 for forming a photo-alignment film, having the following formulation, with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film E1 having a thickness of 0.7 μm, thereby obtaining a TAC film with the photo-alignment film.

Coating liquid E1 for forming photo-alignment film

| | | |
|---|---|---|
| Polymer PA-2 shown below | 100.00 | parts by mass |
| Thermal cationic polymerization | 6.00 | parts by mass |
| initiator PAG-1 shown below | | |
| Diisopropylethylamine | 0.15 | parts by mass |
| Butyl acetate | 622.75 | parts by mass |
| Methyl ethyl ketone | 155.69 | parts by mass |

Polymer PA-2 (weight-average molecular weight: 45,000; numerical values described in each repeating unit represent the content (% by mass) of each repetition with respect to all repeating units)

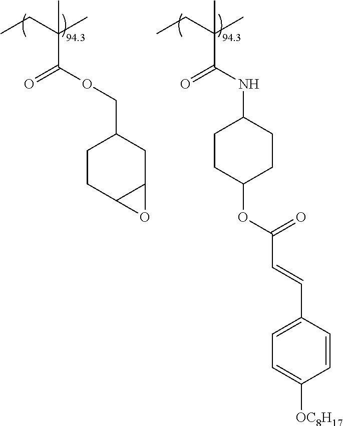

### Thermal Cationic Polymerization Initiator PAG-1

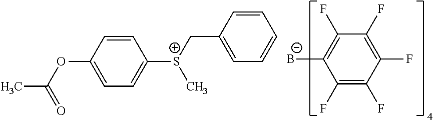

### <Formation of Optical Film F1-1>

The photo-alignment film E1 was coated with a liquid crystal composition F1-1 having the following formulation using a bar coater. The coating film formed on the photo-alignment film E1 was heated to 120° C. with hot air and then cooled to 60° C. The coating film was irradiated with ultraviolet rays at 100 mJ/cm² at a wavelength of 365 nm using a high-pressure mercury lamp in a nitrogen atmosphere, and the coating film was irradiated with ultraviolet rays at 200 mJ/cm² while being heated at 120° C., so that the alignment of the liquid crystal compound was immobilized to form an optical film F1-I, thereby obtaining a laminate F1-1 including the support, the alignment film, and the optical film F1-1 in this order.

A thickness of the optical film F1-1 was 2.9 μm, and Re(550) was 142 nm. In addition, the optical film F1-1 satisfied a relationship of Re(450)<Re(550)<Re(650). Re(450)/Re(550) was 0.82. The optical film F1-1 was an optically anisotropic layer and corresponded to a so-called λ/4 plate.

Liquid crystal composition F1-1

| | | |
|---|---|---|
| Inverse dispersibility compound LA-1 | 30.00 | parts by mass |
| shown below | | |
| Inverse dispersibility compound LA-2 | 30.00 | parts by mass |
| shown below | | |
| Inverse dispersibility compound LA-3 | 27.00 | parts by mass |
| shown below | | |
| Polymerizable liquid crystal compound LC-1 | 6.64 | parts by mass |
| shown below | | |
| Polymerizable liquid crystal compound LC-2 | 1.20 | parts by mass |
| shown below | | |
| Polymerizable liquid crystal compound LC-3 | 0.16 | parts by mass |
| shown below | | |
| Polymerizable liquid crystal compound LC-4 | 5.00 | parts by mass |
| shown below | | |
| The following polymerization initiator PI-1 | 0.50 | parts by mass |
| Leveling agent SA-1 shown below | 0.06 | parts by mass |
| Cyclopentanone | 181.00 | parts by mass |
| Methyl ethyl ketone | 54.00 | parts by mass |

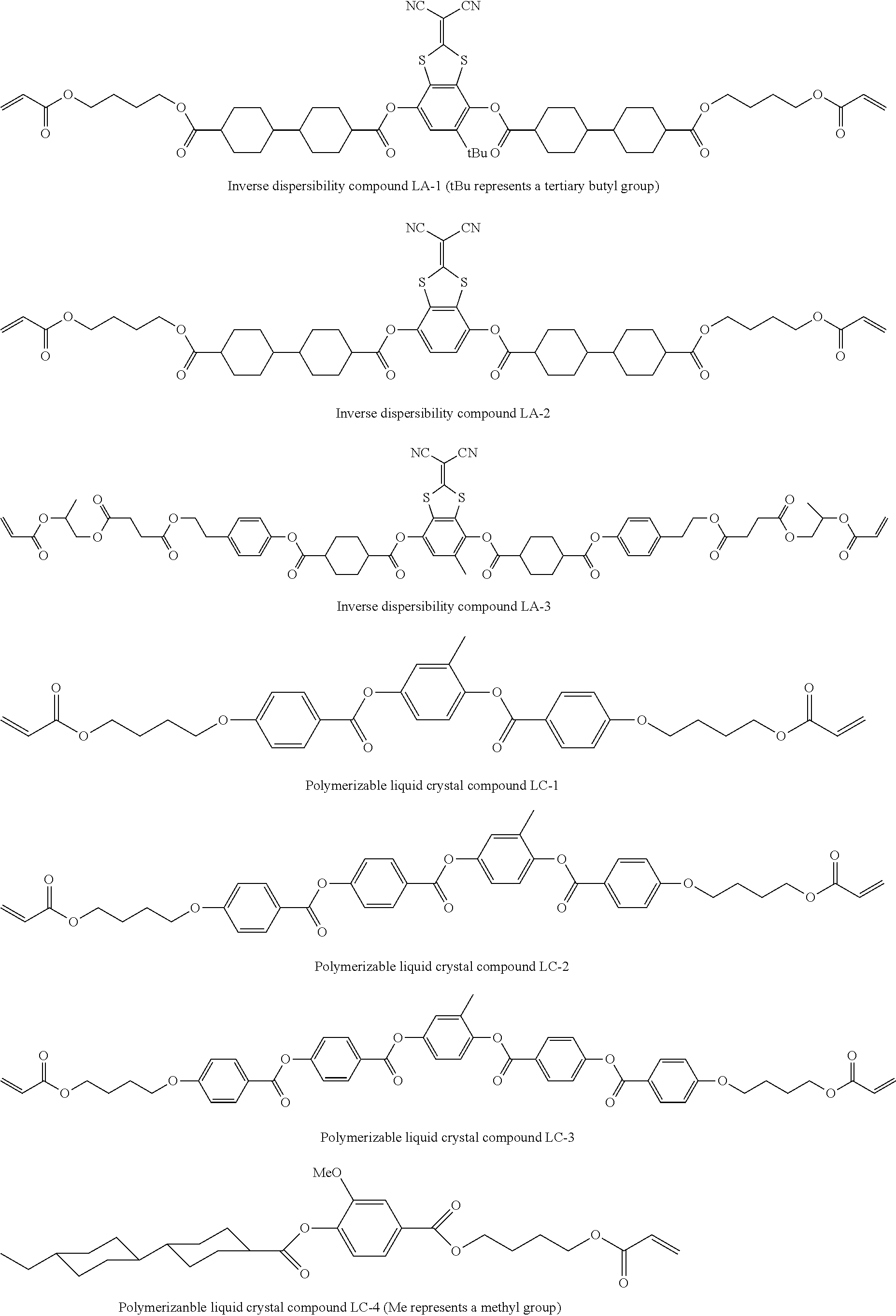

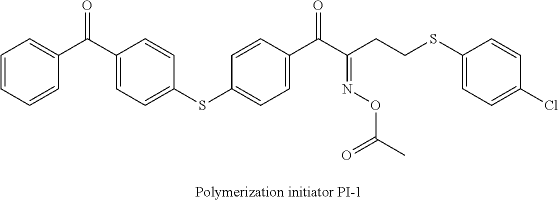 [SMILES: CC(=O)O/N=C(\CCSc1ccc(Cl)cc1)C(=O)c1ccc(Sc2ccc(C(=O)c3ccccc3)cc2)cc1]

Leveling agent SA-1 (weight-average molecular weight: 20,000; the numerical value described in each repeating unit in the main chain represents the content (mass ratio) of each repetition with respect to all repeating units; and the numerical value described in each repeating unit in the side chain represents the number of repeating units.)

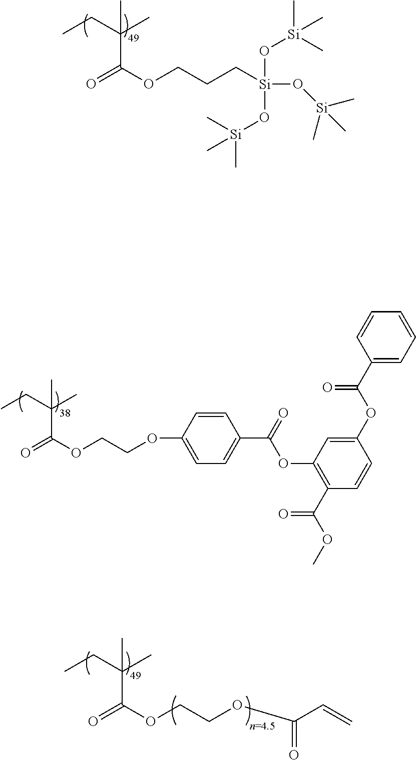

### [Production of Laminate F2-1]

An optical film F2-1 was formed and a laminate F2-1 was produced by the same method as in the laminate F1-1, except that the liquid crystal composition F1-2 in which the addition amount of the leveling agent SA-1 in the liquid crystal composition F1-1 was changed from 0.06 parts by mass to 0.5 parts by mass was used.

### [Production of Laminates F1-2 to F1-5 and F2-2 and F2-3]

The surface of the optical film F1-1 of the laminate F1-1 was subjected to a corona treatment under the conditions shown in Table 1 below to form optical films F1-2 to F1-5, and laminates F1-2 to F1-5 were produced.

The surface of the optical film F2-1 of the laminate F2-1 was subjected to a corona treatment under the conditions shown in Table 1 below to form optical films F2-2 and F2-3, and laminates F2-2 and F2-3 were produced.

### [Production of Laminate F1-6]

The surface of the laminate F1-1 on the optical film F1-1 side was subjected to a plasma treatment under atmospheric pressure to form a laminate F1-6. The plasma treatment was performed using a device having a configuration according to the plasma generating device described in Example 1 of JP2018-170183A. In this case, in the plasma generating device, helium gas, oxygen gas, and nitrogen gas were introduced between the electrode and the counter electrode such that the volume flow rate ratio was 10/0.025/0.5, and a power of 6,000 W was applied to the electrode to generate plasma between the electrode and the counter electrode.

In addition, the transportation speed of the laminate F1-1 transported between the electrode and the counter electrode was 10.0 m/min. The gas composition (analyzed by gas chromatography) of the plasma raw material gas introduced into the plasma generating device was 94.1 vol %/0.4 vol %/5.5 vol % for helium gas, oxygen gas, and nitrogen gas.

### [Production of Positive C-Plate FC-1]

The above-described cellulose acylate film A1 was coated with a coating liquid FC-1 for forming a positive C-plate having the following composition, and the obtained coating film was heated at 60° C. for 60 seconds. Thereafter, the coating film was irradiated with ultraviolet rays of 300 mJ/cm² using an air-cooled metal halide lamp (manufactured by Eye Graphics Co., Ltd.) at 70 mW/cm² in the air to immobilize the alignment state, thereby vertically aligning the liquid crystal compound to form a positive C-plate having a thickness of 0.5 μm and Rth(550)=−60 nm.

Furthermore, the surface of the obtained positive C-plate was subjected to a corona treatment (treatment amount: 1,200 Wmin/m²) to produce a positive C-plate FC-1.

Coating liquid FC-1 for forming positive C-plate

| | | |
|---|---|---|
| Liquid crystal compound LC-1 shown above | 83 | parts by mass |
| Liquid crystal compound LC-2 shown above | 15 | parts by mass |
| Liquid crystal compound LC-3 shown above | 2 | parts by mass |
| Polymerizable monomer (UA-601I, manufactured | 5 | parts by mass |
| by KYOEISHA CHEMICAL Co., LTD.) | | |
| Polymerization initiator (Irgacure | 4 | parts by mass |
| OXE01, manufactured by BASF SE) | | |
| Leveling agent SC-1 shown below | 0.4 | parts by mass |
| Vertical alignment liquid crystal compound | 1.2 | parts by mass |
| alignment agent S01 shown below | | |
| Polymer M shown below | 1.14 | parts by mass |
| Methyl isobutyl ketone | 494.9 | parts by mass |
| Ethyl propionate | 95.0 | parts by mass |
| 2-Butanone | 43.3 | parts by mass |

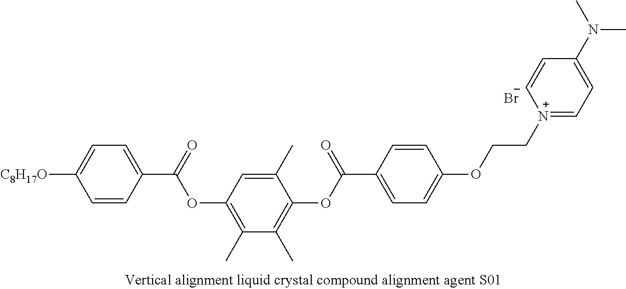

Polymer M (weight-average molecular weight: 60,000; numerical values described in each repeating unit represent a content (mass ratio) of each repeating unit with respect to all repeating units)

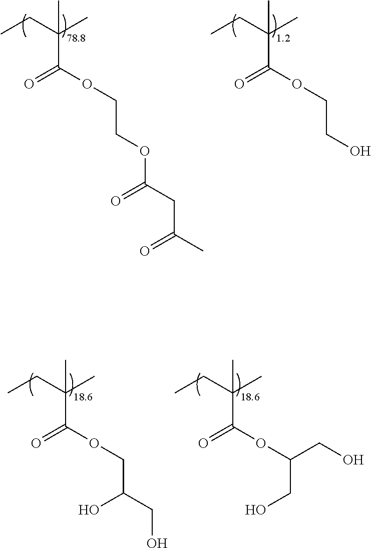

Leveling agent SC-1 (weight-average molecular weight: 25,000; numerical values described in each repeating unit represent a content (mass ratio) of each repeating unit with respect to all repeating units)

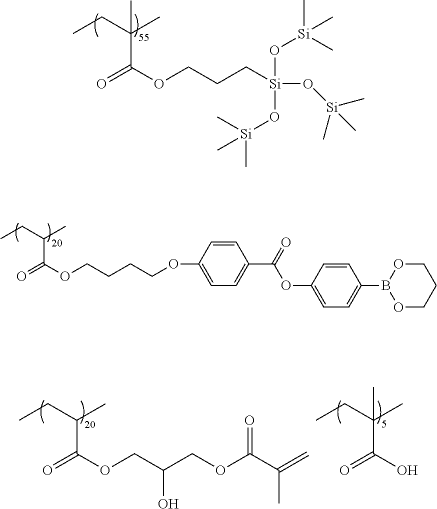

### [Production of Polarizing Plate and Image Display Device]

<Manufacture of Polarizer 1 with Protective Film>

A surface of a support of a cellulose triacetate film TJ25 “Z-TAC” (manufactured by FUJIFILM Corporation, thickness of 25 m) was subjected to an alkali saponification treatment. Specifically, the support was immersed in a 1.5 N sodium hydroxide aqueous solution at 55° C. for 2 minutes, washed in a water washing bath at room temperature, and further neutralized with 0.1 N sulfuric acid at 30° C. After the neutralization, the support was washed in a water washing bath at room temperature and further dried with hot air at 100° C. to obtain a polarizer protective film.

A roll-shaped polyvinyl alcohol film was stretched in a machine direction (MD) in an iodine aqueous solution and dried to obtain a polarizer 1 having a thickness of 14 km.

The polarizer protective film was bonded to both surfaces of the polarizer 1 using a PVA adhesive to produce a polarizer 1 with a protective film.

### [Preparation of UV Adhesive 1]

A UV adhesive 1 having the following composition was prepared.

UV adhesive 1

| | | |
|---|---|---|
| CEL2021P (produced by | 70 | parts by mass |
| DAICEL CORPORATION) | | |
| 1,4-Butanediol diglycidyl ether | 20 | parts by mass |
| 2-Ethylhexyl glycidyl ether | 10 | parts by mass |
| CPI-100P | 2.25 | parts by mass |

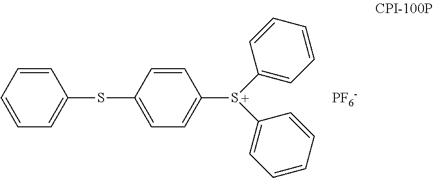

### [Production of Polarizing Plate 1-3]

The positive C-plate side of the positive C-plate FC-1 produced above was bonded to the surface of the optical film F1-3 of the laminate F1-3 using the above-described UV adhesive 1, and the laminate was irradiated with ultraviolet rays of 1,000 mJ/cm² from the positive C-plate FC-1 side to cure the UV adhesive, thereby obtaining a laminate. Subsequently, the alignment film and the cellulose acylate film A1 on the laminate F1-3 side were removed to obtain a laminate with an optical film FI1-3.

The polarizer with a protective film 1 produced above was bonded to the optical film F1-3 side of the laminate with an optical film FI1-3 using a pressure-sensitive gluing agent SK-2057 (manufactured by Soken Chemical & Engineering Co., Ltd.), and the alignment film and the cellulose acylate film A1 on the positive C-plate FC-1 side were removed to complete a polarizing plate 1-3. In this case, the polarizer 1 with a protective film was bonded such that the angle between the absorption axis of the polarizer included in the polarizer 1 with a protective film and the slow axis of the optical film F1-3 was 45°.

### [Production of Polarizing Plates 1-2, 1-4 to 1-6, and 2-3]

Polarizing plates 1-2, 1-4 to 1-5, and 2-3 were produced by the same method as that of the polarizing plate 1-3, except that the laminates F1-2, F1-4 to F1-6, or F2-3 were used instead of the laminate F1-3. In any case, a polarizing plate could be produced.

In a case where the laminates F1-1, F2-1, or F2-2 were used instead of the laminate F1-3, the UV adhesive 1 and the optical film were not closely attached to each other, and a polarizing plate could not be produced.

### [Production of Image Display Device 1]

GALAXY S4 (manufactured by Samsung Electronics Co., Ltd.) equipped with an organic EL panel (organic EL display element) was disassembled, the touch panel provided with a polarizing plate was peeled off from the organic EL display device, the polarizing plate was further peeled off from the touch panel, and the organic EL display element, the touch panel, and the polarizing plate were isolated from each other. Next, the isolated touch panel was bonded to the organic EL display element again, and the polarizing plate 1-3 produced above was bonded onto the touch panel through a pressure-sensitive gluing agent SK-2057 (manufactured by Soken Chemical & Engineering Co., Ltd.) such that the optically anisotropic layer side was on the panel side, thereby producing an organic EL display device 1.

### [Measurement of Film Characteristics]

### [Water Contact Angle]

For the surface of each of the produced optical films (specifically, in Examples 1 to 6 and Comparative Example 3, the surface subjected to the corona treatment or the plasma treatment), a water contact angle was measured using a contact angle meter (manufactured by Kyowa Interface Science Co., Ltd., DMo-702, temperature: 25° C., humidity: 50%, standby time: 20 seconds).

### [XPS Measurement of Film Surface]

The XPS measurement was performed on the surface of each of the produced optical films (specifically, in Examples 1 to 6 and Comparative Example 3, the surface subjected to the corona treatment or the plasma treatment) by the above-described method, and the abundance ratio of the silicon atom and the binding energy of the peak top of the photoelectron spectrum of Si2p on the film surface were obtained. In addition, the obtained photoelectron spectrum of Si2p was subjected to peak separation by the above-described method, and the area ratio of each peak was calculated.

### [Surface Elastic Modulus and Surface Adsorption Force]

The surface of each of the produced optical films (specifically, in Examples 1 to 6 and Comparative Example 3, the surface subjected to the corona treatment or the plasma treatment) was subjected to fitting according to the JKR contact mechanics model with respect to a load/displacement curve obtained under the following apparatus and conditions, and the surface elastic modulus and the surface adsorption force were calculated.
Apparatus: Bruker Dimension Icon
Probe: RTESPA300
Mode: QNM
Maximum load: 100 nN
Indentation depth: <10 nm

### [Evaluation]

### [Adhesiveness]

11 cuts were made in each of the produced polarizing plates at intervals of 1 mm from the positive C-plate side, and 100 grids were formed. A pressure-sensitive adhesive tape (polyester pressure-sensitive adhesive tape NO. 31B, manufactured by NITTO DENKO CORPORATION) was attached to the grid, the tape was peeled off at an angle of about 60°, the number of peeled-off grids was counted, and the evaluation was performed based on the results according to the following standard. It was confirmed by XPS that the peeling interface was an interface between the cured layer of the UV adhesive 1 and the above-described optical film.
A: The number of peeled-off grids was 20 or less.
B: The number of peeled-off grids was 21 or more and 50 or less.
C: The number of peeled-off grids was 51 or more and 90 or less.
D: The number of peeled-off grids was 91 or more, or the UV adhesive and the surface of the optical film were not closely attached, and the polarizing plate could not be produced.

### [Results]

The type and the corona treatment conditions of each optical film are shown in Table 1, and the characteristics of each film surface and the evaluation results are shown in Table 2.

In the following tables, the column of SA-1 (parts by mass) indicates the amount (parts by mass) of the leveling agent SA-1 used in the liquid crystal composition used for forming each optical film.

In the following tables, the column of peak top (eV) indicates the binding energy of the peak top of the photoelectron spectrum of Si2p.

TABLE 1

| | | | | | Amount in |
|---|---|---|---|---|---|
| | | | | Amount | the plasma |
| | | | | in the | treatment |
| | | | | corona | (transpor- |
| | | | SA-1 | treatment | tation |
| | Optical | Polarizing | (parts | (Wmin/ | speed) |
| | film | plate | by mass) | m²) | (m/min) |
| Comparative | F1-1 | 1-1 | 0.06 | — | — |
| Example 1 | | | | | |
| Example 1 | F1-2 | 1-2 | 0.06 | 30 | — |
| Example 2 | F1-3 | 1-3 | 0.06 | 60 | — |
| Example 3 | F1-4 | 1-4 | 0.06 | 200 | — |
| Example 4 | F1-5 | 1-5 | 0.06 | 1200 | — |
| Comparative | F2-1 | 2-1 | 0.5 | — | — |
| Example 2 | | | | | |
| Comparative | F2-2 | 2-2 | 0.5 | 30 | — |
| Example 3 | | | | | |
| Example 5 | F2-3 | 2-3 | 0.5 | 60 | — |
| Example 6 | F1-6 | 1-6 | 0.06 | — | 10 |

TABLE 2

| | | | | | | | | AFM measurement | | |
|---|---|---|---|---|---|---|---|---|---|---|
| | Water | Photoelectron spectroscopy | | | | | | Surface | Surface | |
| | contact | Abundance ratio | Peak | | | | | elastic | adsorption | |
| | angle | of silicon atom | top | Area ratio | | | | modulus | force | Adhesiveness |
| | (°) | (Atomic %) | (eV) | SiO_4 | SiO_3 | SiO_2 | SiO_1 | (GPa) | (nN) | evaluation |
| Comparative | 101 | 3.7 | 101.5 | 0% | 25% | 0% | 75% | 2.2 | 9.1 | D |
| Example 1 | | | | | | | | | | |
| Example 1 | 73 | 3.5 | 102.0 | 5% | 28% | 47% | 20% | 3.9 | 11.5 | C |
| Example 2 | 68 | 3.5 | 102.7 | 41% | 35% | 15% | 9% | 4.8 | 13.8 | B |
| Example 3 | 33 | 3.4 | 103.1 | 95% | 5% | 0% | 0% | 5.0 | 17.5 | B |
| Example 4 | 34 | 2.1 | 103.3 | 100% | 0% | 0% | 0% | 5.2 | 28.2 | A |
| Comparative | 98 | 9.7 | 101.5 | 0% | 25% | 0% | 75% | 2.0 | 8.5 | D |
| Example 2 | | | | | | | | | | |
| Comparative | 73 | 9.8 | 101.5 | 0% | 24% | 4% | 72% | 2.1 | 9.0 | D |
| Example 3 | | | | | | | | | | |
| Example 5 | 67 | 10.1 | 102.1 | 19% | 19% | 12% | 54% | 3.0 | 10.5 | C |
| Example 6 | 35 | 3.4 | 103.3 | 100% | 0% | 0% | 0% | 5.0 | 24.8 | A |

From the above tables, it was confirmed that the film according to the embodiment of the present invention had excellent adhesiveness to an adjacent layer (for example, an adhesive layer).

From the comparison of Examples 1 to 5, it was confirmed that, in a case where the surface elastic modulus was 4.0 GPa or more, the adhesiveness was more excellent, and in a case where the surface elastic modulus was 5.1 GPa or more, the adhesiveness was still more excellent.

From the comparison of Examples 1 to 6, it was confirmed that, in a case where the surface adsorption force was 12.0 nN or more, the adhesiveness was more excellent, and in a case where the surface adsorption force was 20.0 nN or more, the adhesiveness was still more excellent.

From the comparison of Examples 1 to 6, it was confirmed that, in a case where the binding energy of the peak top in the photoelectron spectrum of Si2p obtained by measuring the surface of the film by X-ray photoelectron spectroscopy was 102.5 eV or more, the adhesiveness was more excellent, and in a case where the binding energy of the peak top was 103.2 eV or more, the adhesiveness was still more excellent.

From the comparison of Examples 1 to 6, it was confirmed that, in a case where the peak surface area attributed to the silicon atom to which four oxygen atoms were bonded in the photoelectron spectrum of Si2p obtained by measuring the surface of the film by X-ray photoelectron spectroscopy was 30% or more with respect to the peak surface area of the photoelectron spectrum of Si2p, the adhesiveness was more excellent, and in a case where the peak surface area was 97% or more, the adhesiveness was still more excellent.

In a case where TOF-SIMS was performed on the surface of each optical film, fragments having a molecular weight corresponding to (SiO₂)ₗ (l=1 to 7) were detected in the optical films of Examples 1 to 6. On the other hand, in the optical films of Comparative Examples 1 to 3, the above-described fragments were not detected. That is, it was confirmed that silicon dioxide which was not contained in the liquid crystal composition was generated in the film according to the embodiment of the present invention.

From the above results, it was confirmed that a silicon atom to which four oxygen atoms were bonded was present on the surface of the optical film (specifically, in Examples 1 to 5, the surface subjected to the corona treatment, and in Example 6, the surface subjected to the plasma treatment).

### [Production of Laminate F3-1]

### <Alkali Saponification Treatment of Cellulose Acylate Film A1>

After passing the above-described cellulose acylate film A1 through a dielectric heating roll at a temperature of 60° C. to raise the film surface temperature to 40° C., an alkaline solution having the composition shown below was applied onto a band surface of the film using a bar coater at a coating amount of 14 ml/m², followed by heating to 110° C., and transportation of the film under a steam type far-infrared heater manufactured by Noritake Company Limited for 10 seconds. Subsequently, pure water was applied onto the film at 3 ml/m² using the same bar coater. Next, the film was washed with water by a fountain coater and drained by an air knife three times, and then transported to a drying zone at 70° C. for 10 seconds and dried to produce a cellulose acylate film A1 subjected to an alkali saponification treatment.

Alkaline solution

| | | |
|---|---|---|
| Potassium hydroxide | 4.7 | parts by mass |
| Water | 15.8 | parts by mass |
| Isopropanol | 63.7 | parts by mass |
| Surfactant: C₁₄H₂₉O(CH₂CH₂O)₂₀H | 1.0 | parts by mass |
| Propylene glycol | 14.8 | parts by mass |

### <Formation of Alignment Film Y1>

An alignment film coating liquid having the following formulation was continuously applied onto the surface of the cellulose acylate film A1 which had been subjected to the alkali saponification treatment with a #14 wire bar. The obtained coating film was dried with hot air at 60° C. for 60 seconds, and further dried with hot air at 100° C. for 120 seconds to form an alignment film Y1.

Alignment Film Coating Liquid

| | | |
|---|---|---|
| Polyvinyl alcohol shown below | 10 | parts by mass |
| Water | 371 | parts by mass |
| Methanol | 119 | parts by mass |
| Glutaraldehyde (crosslinking agent) | 0.5 | parts by mass |
| Citric acid ester (manufactured by | 0.175 | parts by mass |
| Sankyo Chemical Co., Ltd.) | | |

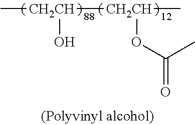

### <Formation of Optical Film F3-1>

The alignment film Y1 produced above was continuously subjected to a rubbing treatment. In this case, the longitudinal direction and the transport direction of the elongated film were parallel to each other, and an angle between the longitudinal direction (transport direction) of the film and the rotation axis of the rubbing roller was 76°. In a case where the longitudinal direction (transport direction) of the film was defined as 90° and the clockwise direction was represented by a positive value with reference to a width direction of the film as a reference (0°) in a case of being observed from the film side, the rotation axis of the rubbing roller was −14°. In other words, the position of the rotation axis of the rubbing roller upon observation from the film side is a position rotated by 760 clockwise with reference to the longitudinal direction of the film.

A liquid crystal composition F3-1 containing a disk-like liquid crystal compound having the following composition was applied onto the alignment film Y1 subjected to the rubbing treatment using a Geeser coating machine to form a composition layer. Next, the obtained composition layer was heated with hot air at 80° C. for 2 minutes for drying of the solvent and alignment aging of the disk-like liquid crystal compound. Subsequently, the obtained composition layer was irradiated with UV (500 mJ/cm²) at 80° C. to immobilize the alignment of the liquid crystal compound, thereby forming an optical film F3-1. In this manner, a laminate F3-1 including the support (cellulose acylate film Al), the alignment film Y1, and the optical film F3-1 in this order was obtained.

A thickness of the optical film F3-1 was 1.4 μm. In addition, an in-plane retardation at a wavelength of 550 nm was 168 nm. It was confirmed that the average tilt angle of the disc plane of the disk-like liquid crystal compound with respect to the film surface was 90°, and the disk-like liquid crystal compound was aligned vertically to the film surface. In addition, in a case where the angle of the in-plane slow axis of the optical film F3-1 was parallel to the rotation axis of the rubbing roller, and the width direction of the film was 0° (the longitudinal direction was 900 in the counterclockwise direction and −90° in the clockwise direction), the in-plane slow axis was −14° in a case of being viewed from the optical film F3-1 side.

Liquid Crystal Composition F3-1

| | | |
|---|---|---|
| Disk-like liquid crystal compound | 80 | parts by mass |
| DL-1 shown below | | |
| Disk-like liquid crystal compound | 20 | parts by mass |
| DL-2 shown below | | |
| Vertical alignment agent V-1 | 1.2 | parts by mass |
| Leveling agent SA-2 shown below | 0.18 | parts by mass |
| Ethylene oxide-modified | 5 | parts by mass |
| trimethylolpropane triacrylate | | |
| (V#360, manufactured by Osaka | | |
| Organic Chemical Industry Ltd.) | | |
| Photopolymerization initiator S-1 | 4.0 | parts by mass |
| Antifoaming agent B-1 | 2.0 | parts by mass |
| Methyl ethyl ketone | 200 | parts by mass |

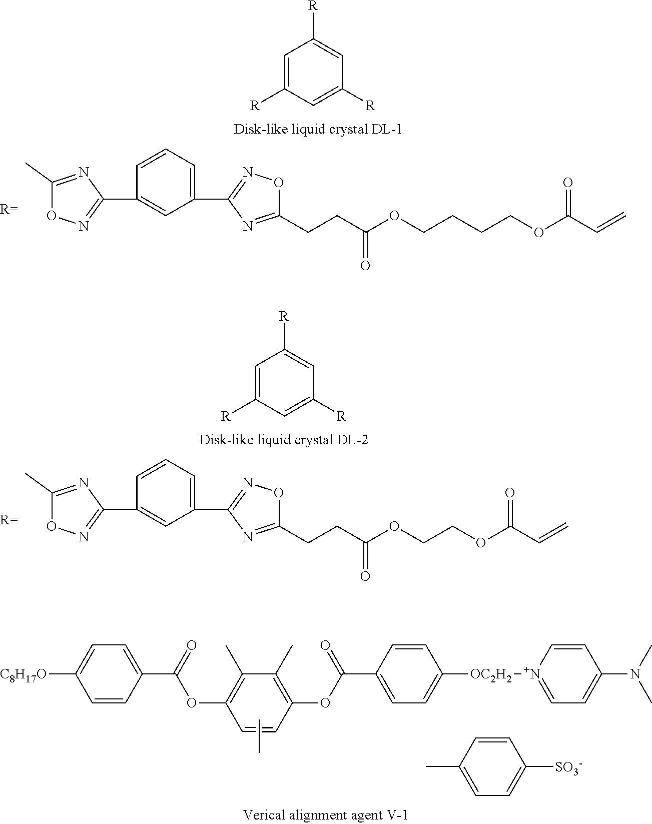

Leveling agent SA-2 (in the formula, a and b represents a content (% by mass) of each repeating unit with respect to all repeating units, and a represents 70% by mass, b represents 24% by mass, and c represents 6% by mass; in addition, a weight-average molecular weight was 18,000)

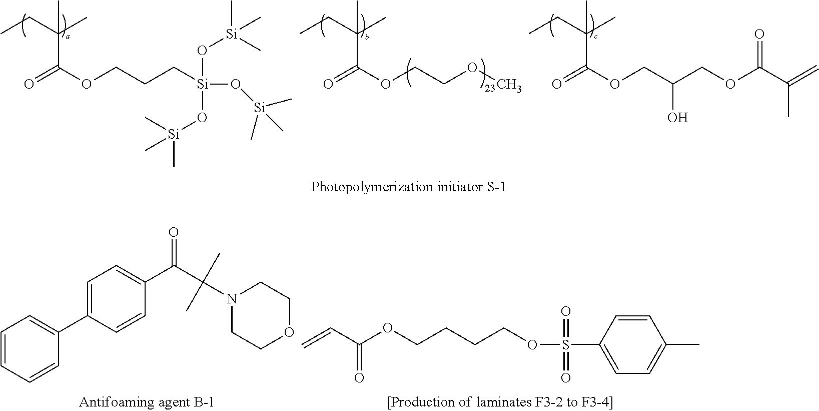

The surface of the optical film F3-1 of the laminate F3-1 was subjected to a corona treatment or a plasma treatment under the conditions shown in Table 3 below to form optical films F3-2 to F3-4, thereby producing laminates F3-2 to F3-4.

### [Production of Laminate F4-1]

A liquid crystal composition F4-1C containing a rod-like liquid crystal compound having the following formulation was applied onto the cellulose acylate film A1 using a geeser coating machine to form a composition layer. Thereafter, both ends of the film were held, a cooling plate (9° C.) was installed on the side of the surface on which the composition layer of the film was formed so that the distance from the film was 5 mm, and a heater (75° C.) was installed on the side opposite to the surface on which the composition layer of the film was formed so that the distance from the film was 5 mm, followed by drying for 2 minutes. Next, the film was heated with hot air at 60° C. for 1 minute, and irradiated with ultraviolet rays having an irradiation amount of 100 mJ/cm² using a 365 nm UV-LED while purging with nitrogen so as to have an atmosphere having an oxygen concentration of 100 ppm or less. Thereafter, the film was annealed with hot air at 120° C. for 1 minute to form an optical film F4-1C.

The obtained optical film F4-1C was irradiated with UV light (ultra-high pressure mercury lamp; UL750; manufactured by HOYA Corporation) at 7.9 mJ/cm² (wavelength: 313 nm) through a wire grid polarizer at room temperature to impart alignment controllability to the surface.

A film thickness of the formed optical film F4-1C was 0.7 μm. The in-plane retardation Re at a wavelength of 550 nm was 0 nm, and the retardation Rth at a wavelength of 550 nm in the thickness direction was −68 nm. It was confirmed that an average tilt angle of a major axis direction of the rod-like liquid crystal compound with respect to the film surface was 90° and the rod-like liquid crystal compound was aligned perpendicular to the film surface.

Liquid crystal composition F4-1C

| | | |
|---|---|---|
| Liquid crystal compound LC-1 shown above | 83 | parts by mass |
| Liquid crystal compound LC-2 shown above | 15 | parts by mass |
| Liquid crystal compound LC-3 shown above | 2 | parts by mass |
| Polymerizable monomer (A-400, manufactured | 4.2 | parts by mass |
| by Shin-Nakamura Chemical Co., Ltd.) | | |
| Polymerization initiator PI-1 shown above | 5.1 | parts by mass |
| Photoacid generator D-1 shown below | 3.0 | parts by mass |
| Polymer M-1 shown below | 2.0 | parts by mass |
| Vertical alignment agent V-2 shown below | 1.9 | parts by mass |
| Photo-alignment polymer P-1 shown below | 0.8 | parts by mass |
| Diisopropylethylamine | 0.2 | parts by mass |
| Methyl ethyl ketone | 23.5 | parts by mass |
| Ethyl propionate | 70.4 | parts by mass |
| Methyl isobutyl ketone | 375.0 | parts by mass |

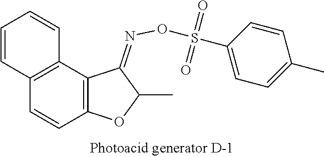 [SMILES: Cc1ccc(S(=O)(=O)O/N=C2/c3c(ccc4ccccc34)OC2C)cc1]

Polymer M-1 (numerical value in each repeating unit represents a content (% by mass) with respect to all repeating units; in addition, a weight-average molecular weight was 60,000)

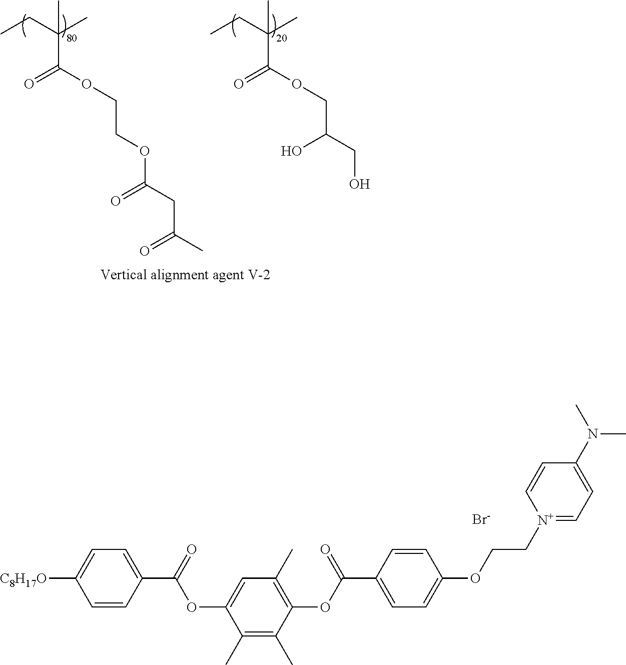

Photo-alignment polymer P-1 (numerical value described in each repeating unit represents a content (% by mass) of each repeating unit with respect to all repeating units; a weight-average molecular weight: 90000; and Me represents methyl group.)

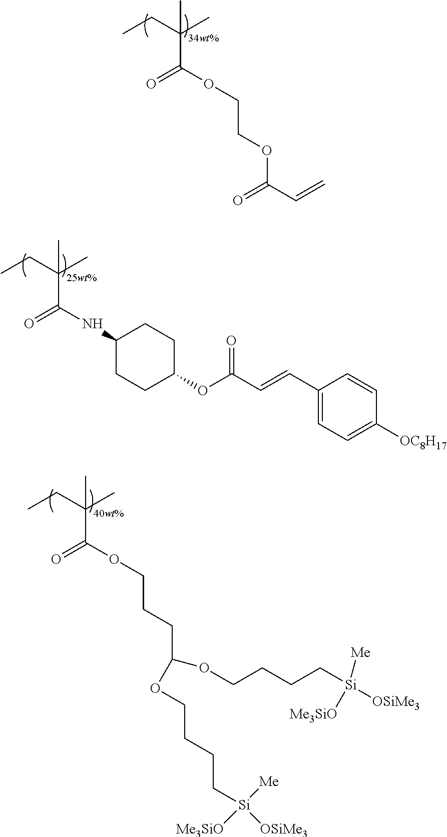

Next, the optical film F4-1C prepared above was coated with a liquid crystal composition F4-1A having the following composition using a geeser coating machine, and heated with hot air at 80° C. for 60 seconds. Subsequently, the obtained composition layer was irradiated with UV (500 mJ/cm²) at 80° C. to immobilize the alignment of the liquid crystal compound, thereby forming an optical film F4-1A and obtaining a laminate F4-1.

A thickness of the optical film F4-1A was 1.5 μm, And at a wavelength of 550 nm was 164 nm, and a twisted angle of the liquid crystal compound was 81°. In a case where the width direction of the film was defined as 0° (the longitudinal direction was defined as 90°), the position of the in-plane slow axis (alignment axial angle of the liquid crystal compound) of the optical film F4-1A was 140 on the air side and 950 on the side in contact with the optical film F4-1C as viewed from the optical film F4-1A side.

The position of the in-plane slow axis of the optical film is represented by a negative value in a case of being clockwise (right-handed) and a positive value in a case of being counterclockwise (left-handed) with the width direction of the film as a reference of 0°, by observing the substrate from the surface side of the optical film.

In addition, the twisted angle of the liquid crystal compound is expressed as negative in a case where the alignment axis direction of the liquid crystal compound on the substrate side (back side) is clockwise (right-handed turning) and positive in a case where it is counterclockwise (left-handed turning) with reference to the alignment axis direction of the liquid crystal compound on the surface side (front side), upon observing the substrate from the surface side of the optical film.

Liquid Crystal Composition F4-1A

| | | |
|---|---|---|
| Liquid crystal compound LC-1 shown above | 58.1 | parts by mass |
| Liquid crystal compound LC-2 shown above | 10.5 | parts by mass |
| Liquid crystal compound LC-3 shown above | 1.4 | parts by mass |
| Rod-like liquid crystal compound (LC-4) | 30.0 | parts by mass |
| shown below | | |
| Ethylene oxide-modified trimethylolpropane | 4.0 | parts by mass |
| triacrylate | | |
| (V#360, manufactured by Osaka | | |
| Organic Chemical Industry Ltd.) | | |
| Photopolymerization initiator | 3.0 | parts by mass |
| (Irgacure 819, manufactured by BASF SE) | | |
| Chiral agent C-1 shown below | 0.48 | parts by mass |
| Leveling agent SA-1 shown above | 0.15 | parts by mass |
| Diisopropylethylamine | 0.70 | parts by mass |
| Ethyl propionate | 126.5 | parts by mass |
| Methyl isobutyl ketone | 126.5 | parts by mass |

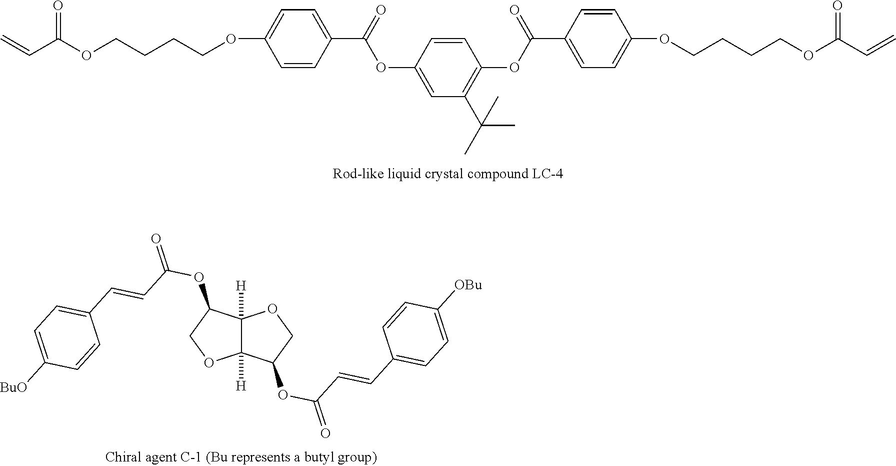

A laminate F4-1 in which the optical film F4-1C and the optical film F4-1A were directly laminated on an elongated cellulose acylate film was manufactured by the above-described procedure.

### [Manufacture of Laminates F4-2 to F4-4]

A corona treatment or a plasma treatment was performed on a surface of the optical film F4-1A of the laminate F4-1 under the conditions shown in Table 3 below to form optical films F4-2A to F4-4A, thereby manufacturing laminates F4-2 to F4-4.

### [Manufacture of Polarizing Plate 3-2]

The surface of the optical film F4-2A of the laminate F4-2 was bonded to the surface of the optical film F3-2 of the laminate F3-2 using the UV adhesive 1, and the laminate was irradiated with ultraviolet rays at 1,000 mJ/cm² from the laminate F4-2 side to cure the UV adhesive, thereby obtaining a laminate. Subsequently, the cellulose acylate film A1 on the laminate F4-2 side was removed to obtain a laminate FI3-2 with an optical film.

The polarizer 1 with a protective film manufactured above was bonded to the optical film F4-2 side of the laminate FI3-2 with an optical film using a pressure-sensitive adhesive SK-2057 (manufactured by Soken Chemical & Engineering Co., Ltd.), and the alignment film and the cellulose acylate film A1 on the laminate F3-2 side were removed to complete a polarizing plate 3-2.

### [Manufacture of Polarizing Plates 3-3 and 3-4]

A polarizing plate 3-3 was manufactured by the same method as that for the polarizing plate 3-2, except that the laminate F3-3 was used instead of the laminate F3-2 and the laminate F4-3 was used instead of the laminate F4-2. In addition, a polarizing plate 3-4 was manufactured by the same method as that for the polarizing plate 3-2, except that the laminate F3-4 was used instead of the laminate F3-2 and the laminate F4-4 was used instead of the laminate F4-2. In any case, a polarizing plate could be produced.

In a case where the laminate F3-1 was used instead of the laminate F3-2 and the laminate F4-1 was used instead of the laminate F4-2, the UV adhesive 1 and the optical film were not closely attached to each other, and a polarizing plate could not be manufactured.

### [Measurement of Film Characteristics]

The characteristics of the surface of each optical film were measured by the same procedure as in Examples 1 to 6 and Comparative Examples 1 to 3.

### [Evaluation]

### [Adhesiveness]

11 cuts were made at intervals of 1 mm in each of the vertical and horizontal directions from the optical film F3-2 to F3-4 side of each of the manufactured polarizing plates 3-2 to 3-4 to form 100 grids. A pressure-sensitive adhesive tape (polyester pressure-sensitive adhesive tape NO. 31B, manufactured by NITTO DENKO CORPORATION) was attached to the grid, the tape was peeled off at an angle of about 60°, the number of peeled-off grids was counted, and the evaluation was performed based on the results according to the following standard. It was confirmed by XPS that the peeling interface was any one of the interface between the cured layer of the UV adhesive 1 and the above-described optical films F3-2 to F3-4, and the interface between the cured layer of the UV adhesive 1 and the above-described optical films F4-2A to F4-4A.
A: The number of peeled-off grids was 20 or less.
B: The number of peeled-off grids was 21 or more and 50 or less.
C: The number of peeled-off grids was 51 or more and 90 or less.
D: The number of peeled-off grids was 91 or more, or the UV adhesive and the surface of the optical film were not closely attached, and the polarizing plate could not be produced.

### [Results]

The type of each optical film, and the corona treatment conditions and the plasma treatment conditions are shown in Table 3, and the characteristics of each film surface and the evaluation results are shown in Table 4. For the optical films F3-2 to F3-4 and the optical films F4-2 to F4-4, the surface subjected to the corona treatment or the plasma treatment was measured.

In the following tables, the column of SA-1 (parts by mass) indicates the amount (parts by mass) of the leveling agent SA-1 used in the liquid crystal composition used for forming each optical film, and the column of SA-2 (parts by mass) indicates the amount (parts by mass) of the leveling agent SA-2 used in the liquid crystal composition used for forming each optical film.

In the following tables, the column of peak top (eV) indicates the binding energy of the peak top of the photoelectron spectrum of Si2p.

TABLE 3

| | Optical film 1 | | Optical film 2 | | | | Amount in the plasma |
|---|---|---|---|---|---|---|---|
| | | SA-2 | | SA-1 | | Amount in the | treatment |
| | | (parts | | (parts | Polarizing | corona treatment | (transportation speed) |
| | | by mass) | | by mass) | plate | (Wmin/m²) | (m/min) |
| Comparative | F3-1 | 0.12 | F4-1 | 0.15 | 3-1 | — | — |
| Example 4 | | | | | | | |
| Example 7 | F3-2 | 0.12 | F4-2 | 0.15 | 3-2 | 100 | — |
| Example 8 | F3-3 | 0.12 | F4-3 | 0.15 | 3-3 | 430 | — |
| Example 9 | F3-4 | 0.12 | F4-4 | 0.15 | 3-4 | — | 10 |

TABLE 4

| | | | Photoelectron spectroscopy | | | | | | | | |
|---|---|---|---|---|---|---|---|---|---|---|---|
| | | | Abundance | | | | | | AFM measurement | | |
| | | Water | ratio of | | | | | | Surface | Surface | |
| | | contact | silicon | Peak | | | | | elastic | adsorption | |
| | Optical | angle | atom | top | Area ratio | | | | modulus | force | Adhesiveness |
| | film | (°) | (Atomic %) | (eV) | SiO_4 | SiO_3 | SiO_2 | SiO_1 | (GPa) | (nN) | evaluation |
| Comparative | F3-1 | 100 | 8.9 | 101.5 | 0% | 25% | 0% | 75% | 4.5 | 11.0 | D |
| Example 4 | F4-1 | 94 | 4.8 | 101.5 | 0% | 25% | 0% | 75% | 3.0 | 9.6 | |
| Example 7 | F3-2 | 62 | 8.5 | 102.6 | 48% | 32% | 14% | 7% | 5.1 | 20.0 | B |
| | F4-2 | 50 | 4.7 | 103.0 | 88% | 10% | 1% | 1% | 5.2 | 19.0 | |
| Example 8 | F3-3 | 32 | 5.0 | 103.2 | 100% | 0% | 0% | 0% | 6.5 | 35.0 | A |
| | F4-3 | 30 | 2.7 | 103.2 | 100% | 0% | 0% | 0% | 5.8 | 30.2 | |
| Example 9 | F3-4 | 30 | 8.7 | 103.2 | 100% | 0% | 0% | 0% | 6.4 | 34.0 | A |
| | F4-4 | 31 | 4.5 | 103.2 | 100% | 0% | 0% | 0% | 5.7 | 28.5 | |

From the comparison of Examples 7 to 9 and Comparative Example 4, it was also confirmed that the film according to the embodiment of the present invention had excellent adhesiveness to an adjacent layer (for example, an adhesive layer).

### EXPLANATION OF REFERENCES

10: laminate
12: liquid crystal layer
14: alignment film
16: support
20: polarizing plate
22: polarizer
24: first closely attached layer
26: second liquid crystal layer
28: second closely attached layer
30: second liquid crystal layer

What is claimed is:

1. A film formed of a liquid crystal composition containing a liquid crystal compound and a leveling agent containing a silicon atom,
wherein a binding energy of a peak top in a photoelectron spectrum of Si2p obtained by measuring a surface of the film by X-ray photoelectron spectroscopy is 102.0 eV or more.

2. A film formed of a liquid crystal composition containing a liquid crystal compound and a leveling agent containing a silicon atom,
wherein a silicon atom to which four oxygen atoms are bonded is present on a surface of the film.

3. The film according to claim 2,
wherein in a photoelectron spectrum of Si2p obtained by measuring the surface of the film by X-ray photoelectron spectroscopy, a peak surface area attributed to the silicon atom to which four oxygen atoms are bonded is 30% or more with respect to a peak surface area of the photoelectron spectrum of Si2p.

4. The film according to claim 1,
wherein a surface elastic modulus of the film is 4.0 GPa or more.

5. The film according to claim 1,
wherein a surface adsorption force of the film is 12.0 nN or more.

6. A polarizing plate comprising:
a polarizer;
an adhesive layer; and
the film according to claim 1.

7. An image display device comprising:
the polarizing plate according to claim 6.

8. The image display device according to claim 7,
wherein the image display device is an organic electroluminescent display device.

9. The image display device according to claim 7,
wherein the image display device is a liquid crystal display device.

10. The film according to claim 2,
wherein a surface elastic modulus of the film is 4.0 GPa or more.

11. The film according to claim 2,
wherein a surface adsorption force of the film is 12.0 nN or more.

12. A polarizing plate comprising:
a polarizer;
an adhesive layer; and
the film according to claim 2.

13. An image display device comprising:
the polarizing plate according to claim 12.

14. The image display device according to claim 13,
wherein the image display device is an organic electroluminescent display device.

15. The image display device according to claim 12,
wherein the image display device is a liquid crystal display device.
